(19) United States
(12) Patent Application Publication
(10) Pub. No.: US 2018/0246848 A1
(43) Pub. Date: Aug. 30, 2018

(54) SYSTEMS, DEVICES, ARTICLES, AND METHODS FOR QUANTUM PROCESSOR ARCHITECTURE

(71) Applicant: D-Wave Systems Inc., Burnaby (CA)

(72) Inventors: Adam Douglass, Vancouver (CA); Richard G. Harris, North Vancouver (CA); Trevor Michael Lanting, Vancouver (CA); Andrew Douglas King, Vancouver (CA); Jack Raymond, Vancouver (CA); Murray C. Thom, Vancouver (CA)

(21) Appl. No.: 15/549,512

(22) PCT Filed: Jan. 27, 2016
(86) PCT No.: PCT/US2016/015100

§ 371 Date: Aug. 8, 2017

Related U.S. Application Data
(60) Provisional application No. 62/114,406, filed on Feb. 10, 2015.

(51) Int. Cl. G06F 15/80; G06N 99/00

(52) U.S. Cl. CPC G06F 15/803; G06N 99/002

(57) ABSTRACT

A topology or hardware graph of a quantum processor is modifiable, for example prior to embedding of a problem, for instance by creating chains of qubits, where each chain which operates as a single or logical qubit to impose a logical graph on the quantum processor. A user interface (UI) allows a user to select a topology suited for embedding a particular problem or type of problem, to supply parameters that define the desired topology, or to supply or specify a problem graph or problem definition from which a processor-based system determines or selects an appropriate topology or logical graph to impose. Topologies may have regularity and/or self-similarity over the quantum processor or portions thereof, which portions may constitute unit cells. Logical graphs imposed on the quantum processor may take the form of a hypercube graph. A UI allows the user to specify a desired dimension of the hypercube graph.

### FIELD

This disclosure generally relates to designs, layouts, and architectures for quantum processors comprising qubits and couplers, and techniques for operating the same.

### BACKGROUND

Quantum devices are structures in which quantum mechanical effects are observable. Quantum devices include circuits in which current transport is dominated by quantum mechanical effects. Such devices include spintronics, where electronic spin is used as a resource, and superconducting circuits. Both spin and superconductivity are quantum mechanical phenomena. Quantum devices can be used for measurement instruments, in computing machinery, and the like.

### Quantum Computation

Quantum computation and quantum information processing are active areas of research and define classes of vendible products. A quantum computer is a system that makes direct use of at least one quantum-mechanical phenomenon, such as, superposition, tunneling, and entanglement, to perform operations on data. The elements of a quantum computer are not binary digits (bits) but typically are quantum binary digits or qubits. Quantum computers hold the promise of providing exponential speedup for certain classes of computation problems like simulating quantum physics. Useful speedup may exist for other classes of problems.

There are several types of quantum computers. An early proposal from Feynman in 1981 included creating artificial lattices of spins. More complicated proposals followed including a quantum circuit model where logical gates are applied to qubits in a time ordered way. In 2000, a model of computing was introduced for solving satisfiability problems; based on the adiabatic theorem this model is called adiabatic quantum computing. This model is believed useful for solving hard optimization problems and potentially other problems.

### Superconducting Qubits

There are solid state qubits based on circuits of superconducting materials. There are two superconducting effects that underlie how superconducting qubits operate: magnetic flux quantization, and Josephson tunneling.

Flux is quantized via the Aharonov-Bohm effect where electrical charge carriers accrue a topological phase when traversing a conductive loop threaded by a magnetic flux. For superconducting loops the charge carries are pairs of electrons called Cooper pairs. For a loop of sufficiently thick superconducting material quantum mechanics dictates that the Cooper pairs accrue a phase that is an integer multiple of 2π. This then constrains the allowed flux in the loop. The flux is quantized. The current in the loop is governed by a single wavefunction and, for the wavefunction to be single-valued at any point in the loop, the flux within is quantized. In other words, superconductivity isn't simply the absence of electrical resistance but rather a quantum mechanical effect.

Josephson tunneling is the process by which Cooper pairs cross an interruption, such as an insulating gap of a few nanometers, between two superconducting electrodes. The amount of current is sinusoidally dependent on the phase difference between the two populations of Cooper pairs in the electrodes. That is, the phase difference across the interruption.

These superconducting effects are present in different configurations and give rise to different types of superconducting qubits including flux, phase, charge, and hybrid qubits. These different types of qubits depend on the topology of the loops, placement of the Josephson junctions, and the physical parameters of the parts of the circuits, such as, inductance, capacitance, and Josephson junction critical current.

### Superconducting Quantum Processor

A plurality of superconducting qubits may be included in a superconducting quantum processor. A superconducting quantum processor may include a number of qubits and associated local bias devices, for instance two or more superconducting qubits. A superconducting quantum processor may also employ couplers (i.e., coupling devices or coupling structures) provide communicative coupling between qubits. A superconducting quantum processor may also include control and read-out devices to read-out and control the state of one or more qubits.

### Adiabatic Quantum Computation

Adiabatic quantum computation typically involves evolving a system from a known initial Hamiltonian (the Hamiltonian being an operator whose eigenvalues are the allowed energies of the system) to a final Hamiltonian by gradually changing the Hamiltonian. A simple example of an adiabatic evolution is a linear interpolation between initial Hamiltonian and final Hamiltonian. An example is given by:

Hₑ=(1−s)Hᵢ+sH_{f} (1)

where Hᵢ is the initial Hamiltonian, H_{f} is the final Hamiltonian, Hₑ is the evolution or instantaneous Hamiltonian, and s is an evolution coefficient which controls the rate of evolution. As the system evolves, the evolution coefficient s goes from 0 to 1 such that at the beginning (i.e., s=0) the evolution Hamiltonian Hₑ is equal to the initial Hamiltonian Hᵢ and at the end (i.e., s=1) the evolution Hamiltonian Hₑ is equal to the final Hamiltonian H_{f}. Before the evolution begins, the system is typically initialized in a ground state of the initial Hamiltonian Hᵢ and the goal is to evolve the system in such a way that the system ends up in a ground state of the final Hamiltonian H_{f} at the end of the evolution. If the evolution is too fast, then the system can transition to a higher energy state, such as the first excited state. In the present systems and devices an “adiabatic” evolution is an evolution that satisfies the adiabatic condition:

\dot{s}| [symbol] 1|dHₑ/ds|0 [symbol] =δg²(S) (2)

where \dot{s} is the time derivative of s, g(s) is the difference in energy between the ground state and first excited state of the system (also referred to herein as the “gap size”) as a function of s, and δ is a coefficient much less than 1. Generally the initial Hamiltonian Hᵢ and the final Hamiltonian H_{f} do not commute. That is, [Hᵢ, H_{f}]≠0.

The process of changing the Hamiltonian in adiabatic quantum computing may be referred to as evolution. If the rate of change, for example, change of s, is slow enough that the system is always in the instantaneous ground state of the evolution Hamiltonian, then transitions at anti-crossings (i.e., when the gap size is smallest) are avoided. The example of a linear evolution schedule is given above. Other evolution schedules are possible including non-linear, parametric, and the like. Further details on adiabatic quantum computing systems, methods, and apparatus are described in, for example, U.S. Pat. Nos. 7,135,701; and 7,418,283.

### Quantum Annealing

Quantum annealing is a computation method that may be used to find a low-energy state, typically preferably the ground state, of a system. Similar in concept to classical simulated annealing, the method relies on the underlying principle that natural systems tend towards lower energy states because lower energy states are more stable. However, while classical annealing uses classical thermal fluctuations to guide a system to a low-energy state and ideally its global energy minimum, quantum annealing may use quantum effects, such as quantum tunneling, as a source of disordering to reach a global energy minimum more accurately and/or more quickly than classical annealing. In quantum annealing thermal effects and other noise may be present to annealing. The final low-energy state may not be the global energy minimum.

Adiabatic quantum computation may be considered a special case of quantum annealing for which the system, ideally, begins and remains in its ground state throughout an adiabatic evolution. Thus, those of skill in the art will appreciate that quantum annealing systems and methods may generally be implemented on an adiabatic quantum computer. Throughout this specification and the appended claims, any reference to quantum annealing is intended to encompass adiabatic quantum computation unless the context requires otherwise.

Quantum annealing uses quantum mechanics as a source of disorder during the annealing process. An objective function, such as an optimization problem, is encoded in a Hamiltonian H_{P}, and the algorithm introduces quantum effects by adding a disordering Hamiltonian H_{D} that does not commute with H_{P}. An example case is:

H_{E}∝A(t)H_{D}+B(t)H_{P}, (3)

where A(t) and B(t) are time dependent envelope functions. For example, A(t) changes from a large value to substantially zero during the evolution and H_{E} may be thought of as an evolution Hamiltonian similar to Hₑ described in the context of adiabatic quantum computation above. The disorder is slowly removed by removing H_{D} (i.e., reducing A(t)). Thus, quantum annealing is similar to adiabatic quantum computation in that the system starts with an initial Hamiltonian and evolves through an evolution Hamiltonian to a final “problem” Hamiltonian H_{P} whose ground state encodes a solution to the problem. If the evolution is slow enough, the system may settle in the global minimum (i.e., the exact solution), or in a local minimum close in energy to the exact solution. The performance of the computation may be assessed via the residual energy (difference from exact solution using the objective function) versus evolution time. The computation time is the time required to generate a residual energy below some acceptable threshold value. In quantum annealing, H_{P} may encode an optimization problem and therefore H_{P} may be diagonal in the subspace of the qubits that encode the solution, but the system does not necessarily stay in the ground state at all times. The energy landscape of H_{P} may be crafted so that its global minimum is the answer to the problem to be solved, and low-lying local minima are good approximations.

The gradual reduction of disordering Hamiltonian H_{D} (i.e., reducing A(t)) in quantum annealing may follow a defined schedule known as an annealing schedule. Unlike adiabatic quantum computation where the system begins and remains in its ground state throughout the evolution, in quantum annealing the system may not remain in its ground state throughout the entire annealing schedule. As such, quantum annealing may be implemented as a heuristic technique, where low-energy states with energy near that of the ground state may provide approximate solutions to the problem. The removal of the disordering Hamiltonian H_{D} may occur after the same Hamiltonian has been added. That, is turn on the disordering Hamiltonian and then off.

### BRIEF SUMMARY

The systems, devices, articles, and methods described herein generally relate to quantum processors comprising qubits, and couplers.

A system for use in quantum processing may be summarized as including: at least one nontransitory processor-readable medium that stores at least one of processor executable instructions or data; and at least one processor communicatively coupled to the least one nontransitory processor-readable medium, and which, in response to execution of the at least one of processor executable instructions or data: causes a presentation of a user interface which includes a set of user selectable logical graphs from which a user may choose for embedding a first problem in a quantum processor, the set of user selectable logical graphs which includes a first and at least a second logical graph, the second logical graph different than the first logical graph; and in response to a selection indicative of selection of one of the user selectable logical graphs, causes a number of chains of qubits of the quantum processor to be formed in a hardware graph of a quantum processor corresponding to the selected one of the logical graphs.

The at least one processor may include at least one digital processor, and the at least one digital processor may cause the presentation of graphical representations of a plurality of user selectable logical graphs. The at least one processor may include at least one digital processor, and the at least one digital processor may cause the presentation of textual representations of a plurality of user selectable logical graphs. The at least one processor may include at least one digital processor, and the at least one digital processor may cause chains of qubits to be formed in the hardware graph on the quantum processor with regularity in both a chain length of each chain of qubits and location of each chain of qubits in at least a first unit cell portion of the quantum processor. The at least one processor may include at least one digital processor, and the at least one digital processor may cause each of a plurality of couplers of the quantum processor to apply a strong ferromagnetic coupling between respective pairs of qubits in each of the chains of qubits to form the respective chain of qubits. The at least one digital processor may be communicatively coupled to control the quantum processor via a control system which applies control signals to the couplers, at least some of the controls signals applied to the couplers to establish the selected logical graph before the first problem is embedded in the quantum processor. The at least one digital processor may be remotely located from the control system, located in a different room from the control system. The at least one digital processor may cause a coupling value between at least one pair of qubits in at least one of the chains of qubits to be distributed over two or more couplers that communicatively couple the qubits of the pair of qubits. Each of the chains of qubits may include a respective logical qubit, and the at least one digital processor may further cause a local bias value to be applied to each of the logical qubits. The at least one digital processor may further cause the local bias value for at least one of the chains of qubits to be distributed over two or more of the qubits of the respective chain of qubits.

A system for use in quantum processing may be summarized as including: at least one nontransitory processor-readable medium that stores at least one of processor executable instructions or data; and at least one processor communicatively coupled to the least one nontransitory processor-readable medium, and which, in response to execution of the at least one of processor executable instructions or data: causes a presentation of a user interface which includes a number of user settable parameters to specify a user defined logical graph; in response to specification of the user settable parameters, causes a number of chains of qubits of the quantum processor to be formed in a hardware graph of a quantum processor corresponding to the specified user settable parameters.

At least one processor may cause presentation of the user interface which includes chain length, chain shape, and repetition pattern as the number of user settable parameters to specify the user defined logical graph, and may cause the number of chains of qubits of the quantum processor to be formed in the hardware graph of the quantum processor based at least in part on the chain length, chain shape, and repetition pattern values specified by the user. The at least one processor may include at least one digital processor, and the at least one digital processor may cause chains of qubits to be formed in the hardware graph on the quantum processor with regularity in both a chain length of each chain of qubits and location of each chain of qubits in at least a first unit cell portion of the quantum processor. The at least one processor may include at least one digital processor, and the at least one digital processor may cause each of a plurality of couplers of the quantum processor to apply a strong ferromagnetic coupling between respective pairs of qubits in each of the chains of qubits to form the respective chain of qubits. The at least one digital processor may be communicatively coupled to control the quantum processor via a control system which applies control signals to the couplers, at least some of the controls signals applied to the couplers to establish the logical graph before the first problem is embedded in the quantum processor. The at least one digital processor may be remotely located from the control system, located in a different room from the control system. The at least one digital processor may cause a coupling value between at least one pair of qubits in at least one of the chains of qubits to be distributed over two or more couplers that communicatively couple the qubits of the pair of qubits. Each of the chains of qubits may include a respective logical qubit, and the at least one digital processor may further cause a local bias value to be applied to each of the logical qubits. The at least one digital processor further may cause the local bias value for at least one of the chains of qubits to be distributed over two or more of the qubits of the respective chain of qubits.

A system for use in quantum processing may be summarized as including: at least one nontransitory processor-readable medium that stores at least one of processor executable instructions or data; and at least one processor communicatively coupled to the least one nontransitory processor-readable medium, and which, in response to execution of the at least one of processor executable instructions or data: causes a presentation of a user interface which allows a user to specify a problem graph; in response to specification of the problem graph by the user, selects a logical graph from a plurality of logical graphs based at least in part on the problem graph; and causes a number of chains of qubits of the quantum processor to be formed in a hardware graph of a quantum processor corresponding to the selected one of the logical graphs.

The at least one processor may include at least one digital processor, and the at least one digital processor may cause the presentation of a graphical representations of a plurality problem graphs. The at least one processor may include at least one digital processor, and the at least one digital processor may cause the presentation of a textual representation of a plurality of least the problem graphs. The at least one processor may include at least one digital processor, and the at least one digital processor may cause the presentation of drawing template that allows the user to draw a representation of the problem graph. The at least one processor may include at least one digital processor, and the at least one digital processor may cause chains of qubits to be formed in the hardware graph on the quantum processor with regularity in both a chain length of each chain of qubits and location of each chain of qubits in at least a first unit cell portion of the quantum processor. The at least one processor may include at least one digital processor, and the at least one digital processor may cause each of a plurality of couplers of the quantum processor to apply a strong ferromagnetic coupling between respective pairs of qubits in each of the chains of qubits to form the respective chain of qubits. The at least one digital processor may be communicatively coupled to control the quantum processor via a control system which applies control signals to the couplers, at least some of the controls signals applied to the couplers to establish the selected logical graph before the first problem is embedded in the quantum processor. The at least one digital processor may be remotely located from the control system, located in a different room from the control system. The at least one digital processor may cause a coupling value between at least one pair of qubits in at least one of the chains of qubits to be distributed over two or more couplers that communicatively couple the qubits of the pair of qubits. Each of the chains of qubits may include a respective logical qubit, and the at least one digital processor may further cause a local bias value to be applied to each of the logical qubits. The at least one digital processor may further cause the local bias value for at least one of the chains of qubits to be distributed over two or more of the qubits of the respective chain of qubits.

A system for use in quantum processing may be summarized as including: at least one nontransitory processor-readable medium that stores at least one of processor executable instructions or data; at least one processor communicatively coupled to the least one nontransitory processor-readable medium, and which, in response to execution of the at least one of processor executable instructions or data: causes a presentation of a user interface which allows a user to specify a first value for a dimension of a hypercube graph at a first time; and based at least in part on the first value for the dimension of the hypercube graph, causes a first number of chains of qubits of the quantum processor to be formed in a hardware graph of a quantum processor to implement a first logical graph in the hardware graph of the quantum processor, the first logical graph which corresponds to the hypercube graph of the dimension specified by the first value.

The at least one of processor may further: cause a presentation of the user interface which allows the user to specify a second value for a dimension of a hypercube graph at a second time, the second value different from the first value and the second time different from the first time; and based at least in part on the second value for the dimension of the hypercube graph, may cause a second number of chains of qubits of the quantum processor to be formed in the hardware graph of the quantum processor to implement a second logical graph in the hardware graph of the quantum processor, the second logical graph which corresponds to the hypercube graph of the dimension specified by the second value. The second value may be less than the first value, and the at least one processor may cause the hypercube graph to collapse. The second value may be less than the first value, and the at least one processor may cause the hypercube graph to expand. The at least one processor may include at least one digital processor, and the at least one digital processor may cause the presentation of at least one of a set of integers or an integer entry field to specify the dimension of the hypercube graph. The at least one processor may include at least one digital processor, and the at least one digital processor may cause chains of qubits to be formed in the hardware graph on the quantum processor with regularity in both a chain length of each chain of qubits and location of each chain of qubits in at least a first unit cell portion of the quantum processor. The at least one processor may include at least one digital processor, and the at least one digital processor may cause each of a plurality of couplers of the quantum processor to apply a strong ferromagnetic coupling between respective pairs of qubits in each of the chains of qubits to form the respective chain of qubits. The at least one digital processor may be communicatively coupled to control the quantum processor via a control system which applies control signals to the couplers, at least some of the controls signals applied to the couplers to establish the selected logical graph before the first problem is embedded in the quantum processor. The at least one digital processor may be remotely located from the control system, located in a different room from the control system. The at least one digital processor may cause a coupling value between at least one pair of qubits in at least one of the chains of qubits to be distributed over two or more couplers that communicatively couple the qubits of the pair of qubits. Each of the chains of qubits may include a respective logical qubit, and the at least one digital processor may further cause a local bias value to be applied to each of the logical qubits. The at least one digital processor may further cause the local bias value for at least one of the chains of qubits to be distributed over two or more of the qubits of the respective chain of qubits.

A quantum processing system may be summarized as including: at least one quantum processor that comprises a plurality of qubits and a plurality of couplers; at least one control system communicatively coupled to the least one quantum processor to, prior to an embedding of a problem in a hardware graph of the quantum processor, selectively form chains of qubits to embed a first logical graph of a first size n in at least one unit cell of the hardware graph of the quantum processor, where the number of qubits in the logical graph available to embed the problem is equal to 2ⁿ, the number of couplers between the qubits available to embed the problem is equal to n*2⁽ⁿ⁻¹⁾, and the number edges in the at least one unit cell and incident on each qubit in the at least one unit cell is n.

The first logical graph may be a hypercube graph of size n. The hypercube graph may be of size 4 and each qubit available to embed the problem in the first logical graph may be proximate four couplers which are each available to embed the problem. The quantum processing system may further include: at least one nontransitory processor-readable medium that stores at least one of processor executable instructions or data; and at least one processor communicatively coupled to the least one nontransitory processor-readable medium, and which, in response to execution of the at least one of processor executable instructions or data causes a presentation of a user interface which allows a user to specify at least one aspect of the first logical graph prior to embedding the first problem in the first logical graph. The user interface may include at least one of: at least one user interface element to select from a set of user selectable logical graphs from which the user may choose for embedding a first problem in a quantum processor; and at least one user interface element to specify a number of user settable parameters of a user defined logical graph; at least one user interface element to specify a problem graph; or at least one user interface element to specify a value for a dimension of a hypercube graph.

A method of operation in a hybrid computer that comprises both quantum processor and at least one processor-based device communicatively coupled to one another, the quantum processor comprising a plurality of qubits, and a plurality of couplers, wherein each coupler provides controllable communicative coupling between two of the plurality of qubits may be summarized as including: presenting a user interface which includes a set of user selectable logical graphs from which a user may choose for embedding a first problem in a quantum processor, the set of user selectable logical graphs which includes a first and at least a second logical graph, the second logical graph different than the first logical graph; and in response to a selection indicative of selection of one of the user selectable logical graphs, forming a number of chains of qubits in a hardware graph of a quantum processor in accordance with the selected one of the logical graphs.

The method may further include: causing the presentation of graphical representations of a plurality of user selectable logical graphs. The method may further include causing the presentation of textual representations of a plurality of user selectable logical graphs. The method may further include: causing chains of qubits to be formed in the hardware graph on the quantum processor with regularity in both a chain length of each chain of qubits and location of each chain of qubits in at least a first unit cell portion of the quantum processor. The method may further include: causing each of a sub-set of the plurality of couplers of the quantum processor to apply a strong ferromagnetic coupling between respective pairs of qubits in each of the chains of qubits to form the respective chain of qubits. The at least one processor-based device may be communicatively coupled to control the quantum processor via a control system, and the method may further include applying control signals to the couplers, wherein at least some of the controls signals applied to the couplers to establish the selected logical graph before the first problem is embedded in the quantum processor. The method may further include: causing a coupling value between at least one pair of qubits in at least one of the chains of qubits to be distributed over two or more couplers that communicatively couple the qubits of the pair of qubits. The method may further include: applying a local bias value for a respective logical qubit comprised of a respective chain of qubits to the respective logical qubit. The method may further include: distributing the local bias value for the respective logical qubit comprised of the respective chains of qubits over two or more qubits in the respective chain of qubit.

A method of operation in a hybrid computer that comprises both quantum processor and at least one processor-based device communicatively coupled to one another, the quantum processor comprising a plurality of qubits, and a plurality of couplers, wherein each coupler provides controllable communicative coupling between two of the plurality of qubits may be summarized as including: presenting a user interface which includes a number of user settable parameters to specify a user defined logical graph; in response to specification of the user settable parameters, forming a number of chains of qubits in a hardware graph of the quantum processor corresponding to the specified user settable parameters.

The method may further include: causing presentation of the user interface which includes a presentation of chain length, chain shape, and repetition pattern as the number of user settable parameters to specify the user defined logical graph, and forming the number of chains of qubits in the hardware graph of the quantum processor based at least in part on chain length, chain shape, and repetition pattern values specified by the user. The method may further include: forming the number of chains of qubits in the hardware graph of the quantum processor with regularity in both a chain length of each chain of qubits and location of each chain of qubits in at least a first unit cell portion of the quantum processor. The method may further include: causing each of a sub-set of the plurality of couplers of the quantum processor to apply a strong ferromagnetic coupling between respective pairs of qubits in each of the chains of qubits to form the respective chain of qubits. The at least one processor-based device may be communicatively coupled to control the quantum processor via a control system which applies control signals to the couplers, at least some of the controls signals applied to the couplers to establish the user defined logical before a first problem is embedded in the quantum processor. The method may further include: causing a coupling value between at least one pair of qubits in at least one of the chains of qubits to be distributed over two or more couplers that communicatively couple the qubits of the at least one pair of qubits. The method may further include: applying a local bias value for a respective logical qubit comprised of a respective chain of qubits to the respective logical qubit. The method may further include: distributing the local bias value for the respective logical qubit comprised of the respective chain of qubits over two or more qubits in the respective chain of qubit.

A method of operation in a hybrid computer that comprises both quantum processor and at least one processor-based device communicatively coupled to one another, the quantum processor comprising a plurality of qubits, and a plurality of couplers, wherein each coupler provides controllable communicative coupling between two of the plurality of qubits may be summarized as including: causing a presentation of a user interface which allows a user to specify a first value for a dimension of a hypercube graph at a first time; and based at least in part on the first value for the dimension of the hypercube graph, causing a first number of chains of qubits of the quantum processor to be formed in a hardware graph of a quantum processor to implement a first logical graph in the hardware graph of the quantum processor, the first logical graph which corresponds to the hypercube graph of the dimension specified by the first value.

The method may further include: causing a presentation of the user interface which allows the user to specify a second value for a dimension of a hypercube graph at a second time, the second value different from the first value and the second time different from the first time; and based at least in part on the second value for the dimension of the hypercube graph, causing a second number of chains of qubits of the quantum processor to be formed in the hardware graph of the quantum processor to implement a second logical graph in the hardware graph of the quantum processor, the second logical graph which corresponds to the hypercube graph of the dimension specified by the second value. The method may further include: collapsing the hypercube graph when the second value is less than the first value, and the at least one processor. The method may further include: expanding the hypercube graph when the second value is less than the first value. The method may further include: presenting at least one of a set of integers or an integer entry field to specify the dimension of the hypercube graph. The method may further include: forming chains of qubits in the hardware graph on the quantum processor with regularity in both a chain length of each chain of qubits and location of each chain of qubits in at least a first unit cell portion of the quantum processor. The method may further include: causing each of a sub-set of the plurality of couplers of the quantum processor to apply a strong ferromagnetic coupling between respective pairs of qubits in each of the chains of qubits to form the respective chain of qubits. The at least one processor-based device may be communicatively coupled to control the quantum processor via a control system which applies control signals to the couplers, at least some of the controls signals applied to the couplers to establish the selected logical graph before the first problem is embedded in the quantum processor. The at least one processor-based device may cause a coupling value between at least one pair of qubits in at least one of the chains of qubits to be distributed over two or more couplers that communicatively couple the qubits of the pair of qubits. The method may further include: applying a local bias value for a respective logical qubit comprised of a respective chain of qubits to the respective logical qubit. The at least one digital processor may further cause the local bias value for at least one of the chains of qubits to be distributed over two or more of the qubits of the respective chain of qubits.

A quantum processor may be summarized as including: a plurality of unit cells tiled over an area such that each unit cell is positioned adjacent at least one other unit cell, each unit cell comprising: a first set of qubits, a second set of qubits, a third set of qubits, a fourth set of qubits, each of the qubits of the first set of qubits, the second set of qubits, the third set of qubits, and the fourth sets of qubits having a respective major axis, the major axes of the qubits of the first set parallel with one another along at least a first portion of a length thereof, the major axes of the qubits of the second set parallel with one another along at least a first portion of a length thereof, the major axes of the qubits of the third set parallel with one another along at least a first portion of a length thereof, and the major axes of the qubits of the fourth set parallel with one another along at least a first portion of a length thereof, the major axes of the qubits of the first of qubits nonparallel with the major axes of the qubits of the second set of qubits, the major axes of the qubits of the second set of qubits nonparallel with the major axes of the qubits of the third set of qubits, the major axes of the qubits of the third set of qubits nonparallel with the major axes of the qubits of the fourth set of qubits, each qubit in the first set of qubits crosses at least one qubit in the second set of qubits and at least one qubit in the fourth set of qubits, each qubit in the third set of qubits crosses at least one qubit in the second set of qubits and at least one qubit in the fourth set of qubits, and for each unit cell none of the qubits of the respective unit cell cross any of the respective qubits of any other one of the unit cells; a first set of intra-cell couplers comprising: a first sub-set of the first set of intra-cell couplers, wherein each coupler in first sub-set of the first set of intra-cell couplers is positioned proximate a respective point where a respective one of qubits in the first set of qubits crosses one of the qubits in the second set of qubits and provides controllable communicative coupling between the qubit in the first set of qubits and the respective qubit in the second set of qubits, a second sub-set of the first set of intra-cell couplers, wherein each coupler in the second sub-set of the first set of intra-cell couplers is positioned proximate a respective point where a respective one of qubits in the second set of qubits crosses one of the qubits in the third set of qubits and provides controllable communicative coupling between the qubit in the second set of qubits and the respective qubit in the third set of qubits, a third sub-set of the first set of intra-cell couplers, wherein each coupler in the third sub-set of the first set of intra-cell couplers is positioned proximate a respective point where a respective one of qubits in the third set of qubits crosses one of the qubits in the fourth set of qubits and provides controllable communicative coupling between the qubit in the third set of qubits and the respective qubit in the fourth set of qubits, a fourth sub-set of the first set of intra-cell couplers, wherein each coupler in the fourth sub-set of the first set of intra-cell couplers is positioned proximate a respective point where a respective one of qubits in the fourth set of qubits crosses one of the qubits in the first set of qubits and provides controllable communicative coupling between the qubit in the fourth set of qubits and the respective qubit in the first set of qubits; and a second set of intra-cell couplers, wherein each coupler in the second set of intra-cell couplers is positioned proximate a respective point at which each at least one qubit in a respective set of qubits crosses the at least one other qubit in the respective set of qubits and provides controllable communicative coupling between the at least one qubit in the respective set of qubits and the at least one other qubit in the respective set of qubits.

The first portion of the length of the major axis of the qubits of the first set may be a majority; the first portion of the length of the major axis of the qubits of the second set may be a majority; the first portion of the length of the major axis of the qubits of the third set may be a majority; and the first portion of the length of the major axis of the qubits of the fourth set may be a majority. The quantum processor may include a multi-layered superconducting integrated circuit. The at least one qubit in the first set of qubits which crosses the at least one other qubit in the first set of qubits may have a substantially Z-shape profile. The at least one other qubit in the first set of qubits which the at least one qubit in the first set crosses may have a substantially Z-shape profile and is a mirror image of the Z-shape profile of the at least one qubit in the first set. The respective major axis of each qubit in the first set of qubits may be perpendicular to the respective major axis of each qubit in the second set of qubits such that each qubit in the first set of qubits perpendicularly crosses at least one qubit in the second set of qubits. The quantum processor may further include: a set of inter-cell couplers, wherein each inter-cell coupler in the set of inter-cell couplers is positioned between a pair of qubits in at least one adjacent unit cell and provides controllable communicative coupling between the pair of qubits in the at least one adjacent unit cell. The quantum processor may further include: a set of inter-cell couplers, wherein each inter-cell coupler in the set of inter-cell couplers is positioned between a pair of qubits in at least one horizontally or vertically adjacent unit cell and provides controllable communicative coupling between the pair of qubits in the horizontally or vertically adjacent unit cells.

A method of operation in a hybrid computer may be summarized as including both a quantum processor and at least one processor-based device communicatively coupled to one another, the quantum processor comprising a plurality of qubits, and a plurality of couplers for the quantum processor via the at least one processor-based device, wherein the first configuration and the second configuration corresponds to the objective function, evolving the quantum processor via an evolution subsystem, and reading out states for the qubits in plurality of qubits of the quantum processor via a readout subsystem, wherein the states for the qubits in the plurality of qubits correspond to a sample in the first plurality of samples.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of an exemplary hybrid computing system including a digital processor and quantum processor in accordance with the presently described systems, devices, articles, and methods.

FIG. 2 illustrates a portion of an exemplary superconducting quantum processor in accordance with the presently described systems, devices, articles, and methods.

FIG. 3 is a schematic diagram of an exemplary unit cell forming the basis of a quantum processor architecture in accordance with the presently described systems, devices, articles, and methods.

FIG. 4 is a qubit graph illustrating the interconnections realized between the qubits in the quantum processor architecture from FIG. 3, in accordance with the presently described systems, devices, articles, and methods.

FIGS. 5-7 are qubit graphs illustrating embedded topologies for the qubits in a quantum processor architecture, in accordance with the presently described systems, devices, articles, and methods.

FIGS. 8-11 are plots illustrating adjacency matrices for logical graphs corresponding to the embedded topologies in FIGS. 4-7, respectively, in accordance with the presently described systems, devices, articles, and methods.

FIG. 12 is a schematic diagram showing the process of reducing a family graphs by successively applying an embedded topology method, in accordance with the presently described systems, devices, articles, and methods.

FIG. 13 is a qubit graph illustrating an embedded topology for the qubits in a quantum processor architecture, in accordance with the presently described systems, devices, articles, and methods.

FIG. 14 is a schematic diagram of an exemplary unit cell forming at least a portion of a quantum processor architecture in accordance with the presently described systems, devices, articles, and methods.

FIG. 15 is a flow diagram showing a high-level method of operation in a computational system including one or more quantum processors to correct for biases in couplers of the one or more quantum processors, in accordance with the presently described systems, devices, articles, and methods.

FIG. 16 is a flow diagram showing a high-level method of operation in a computational system including one or more quantum processors to correct for biases in logical qubits of the one or more quantum processors, in accordance with the presently described systems, devices, articles, and methods.

FIG. 17 is a flow-diagram showing a method of using an embedded topology for a quantum processor in accordance with the presently described systems, devices, articles, and methods.

FIG. 18 is a flow-diagram showing a method of using an embedded topology for a quantum processor in accordance with the presently described systems, devices, articles, and methods.

FIG. 19 is a flow-diagram showing a method for selecting an embedded topology for a quantum processor in accordance with the presently described systems, devices, articles, and methods.

### DETAILED DESCRIPTION

In the following description, some specific details are included to provide a thorough understanding of various disclosed embodiments. One skilled in the relevant art, however, will recognize that embodiments may be practiced without one or more of these specific details, or with other methods, components, materials, etc. In other instances, well-known structures associated with quantum processors, such as quantum devices, couplers, and control systems including microprocessors and drive circuitry have not been shown or described in detail to avoid unnecessarily obscuring descriptions of the embodiments of the present methods. Throughout this specification and the appended claims, the words “element” and “elements” are used to encompass, but are not limited to, all such structures, systems, and devices associated with quantum processors, as well as their related programmable parameters.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” “an embodiment”, “another embodiment”, “one example”, “an example”, or “another example” means that a particular referent feature, structure, or characteristic described in connection with the embodiment or example is included in at least one embodiment or example. Thus, the appearances of the phrases “in one embodiment”, “in an embodiment”, “another embodiment” or the like in various places throughout this specification are not necessarily all referring to the same embodiment or example. Furthermore, the particular features, structures, or characteristics may be combined in any suitable manner in one or more embodiments or examples.

It should be noted that, as used in this specification and the appended claims, the singular forms “a,” “an,” and “the” include plural referents unless the content clearly dictates otherwise. Thus, for example, reference to a problem-solving system including “a quantum processor” includes a single quantum processor, or two or more quantum processors. It should also be noted that the term “or” is generally employed in its sense including “and/or” unless the content clearly dictates otherwise.

The headings provided herein are for convenience only and do not interpret the scope or meaning of the embodiments.

The present systems, devices, articles, and methods relate to quantum processors comprising qubits and couplers. In some examples, a hybrid computer, including a quantum processor, presents to a user, or calling application, a new logical graph based on a hardware graph of the quantum processor. This new logical graph is created through a technique called embedded topologies. In some examples, the new logical graph includes a higher average degree of connectivity. In some examples, the new logical graph allows the hybrid computer to define a problem on the quantum processor with increased precision by changing the dynamic range by which problem Hamiltonian parameters are specified within.

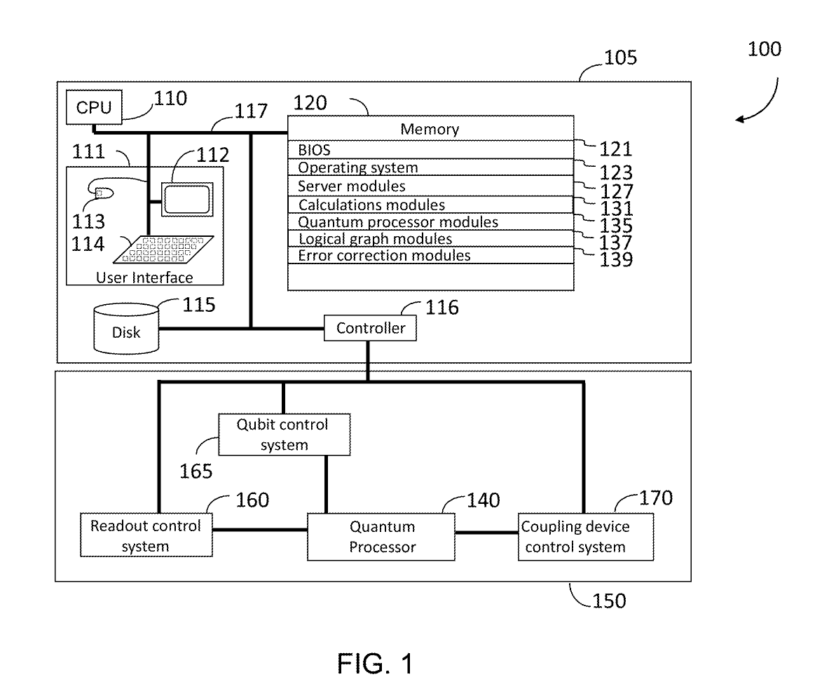

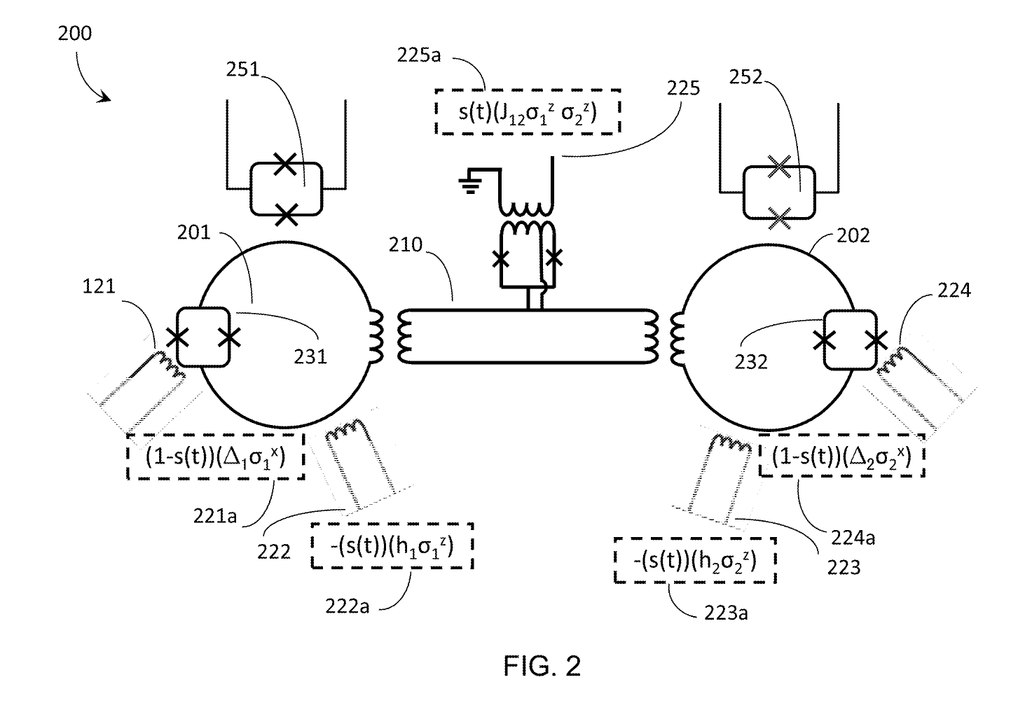

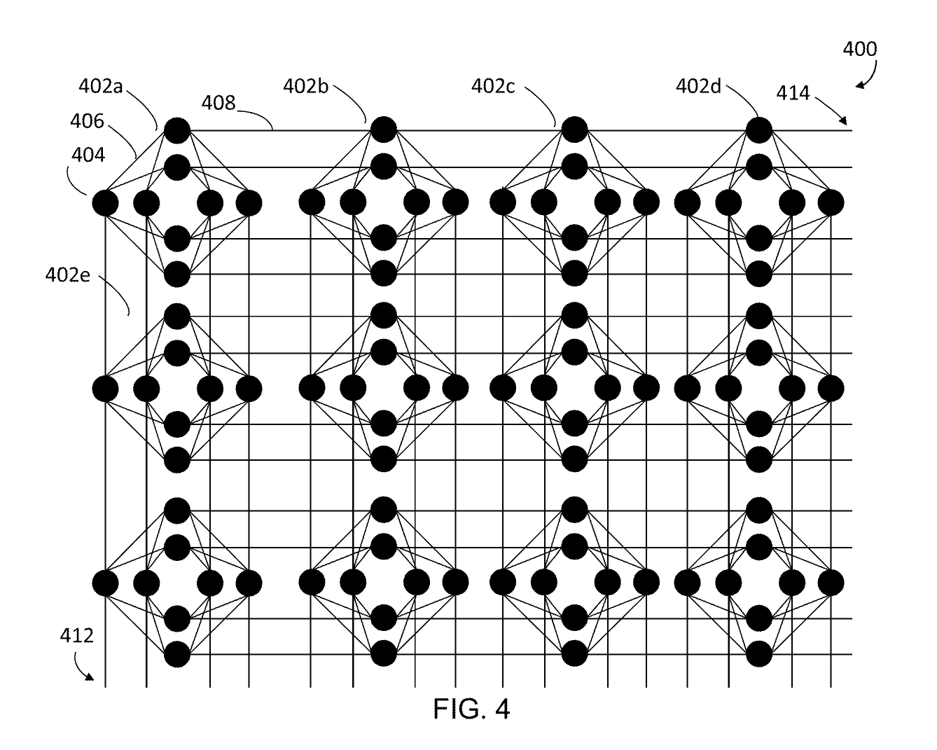

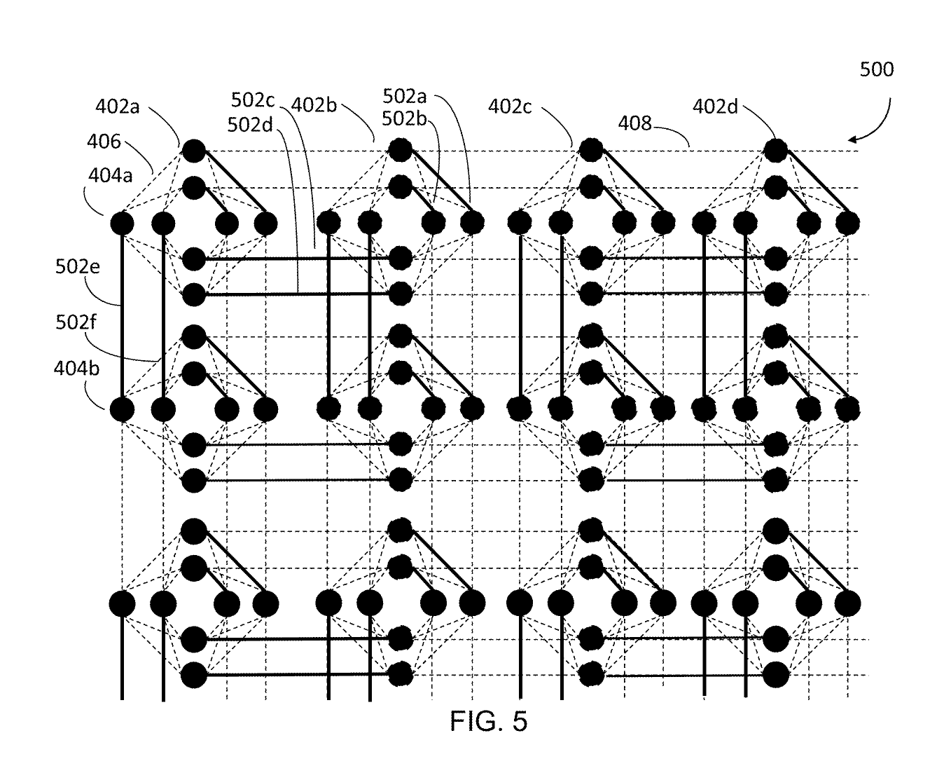

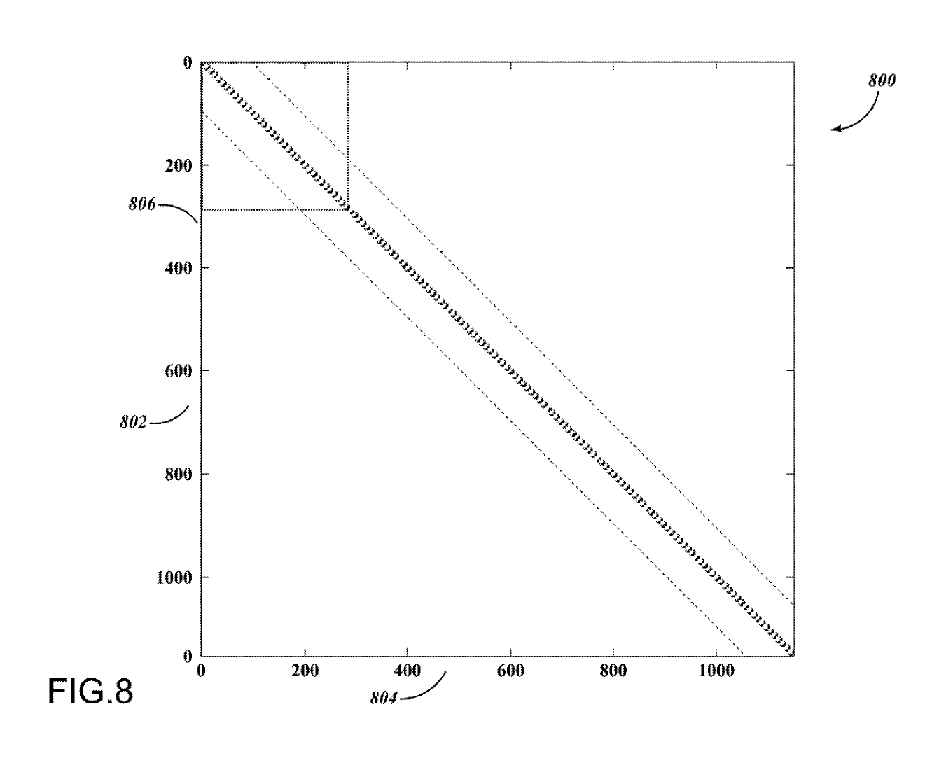

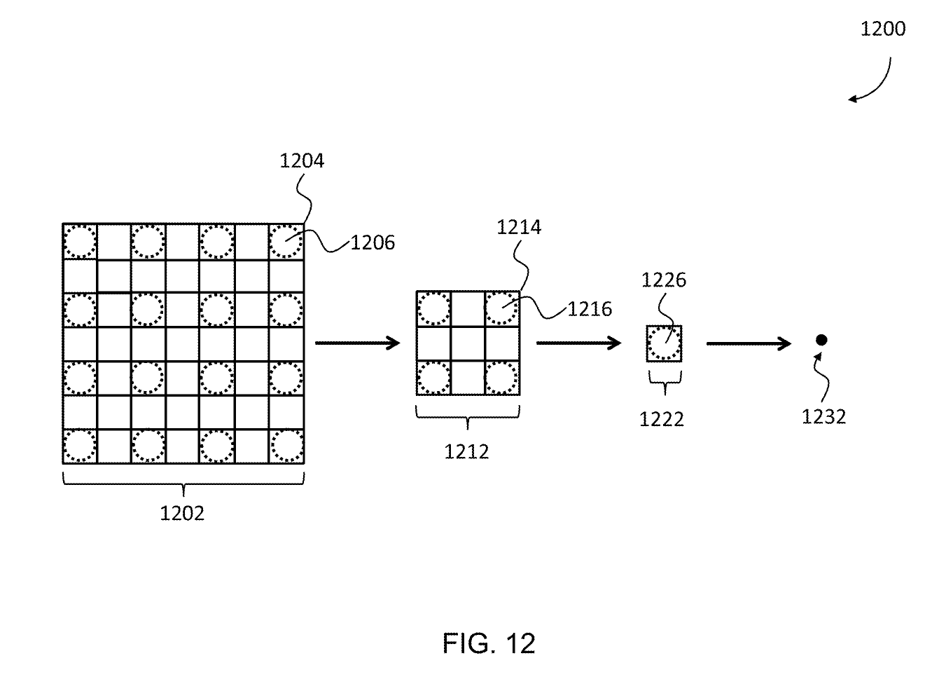

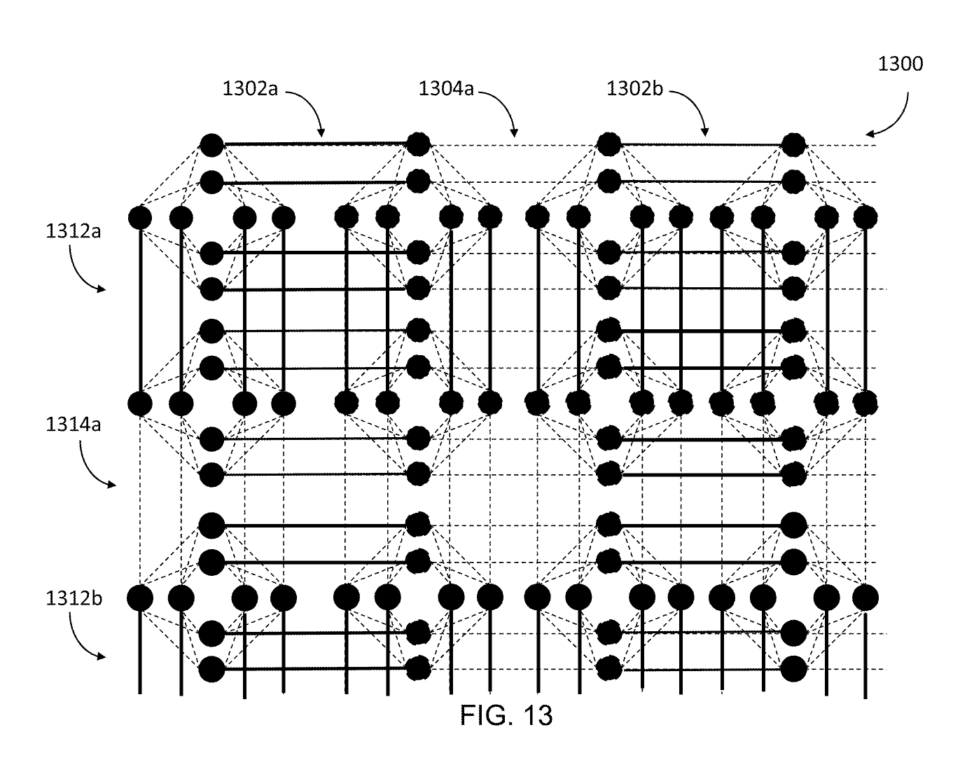

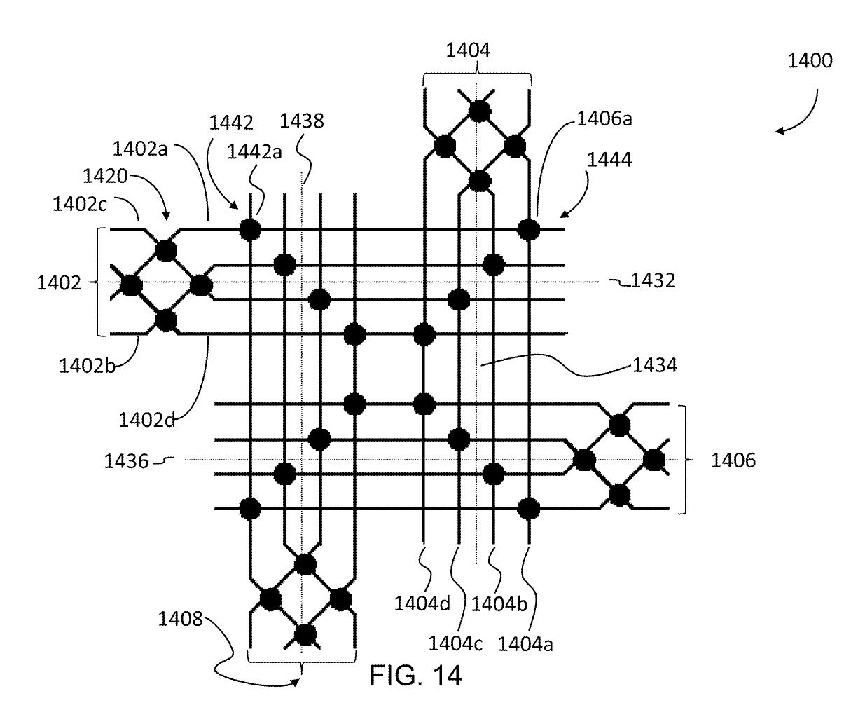

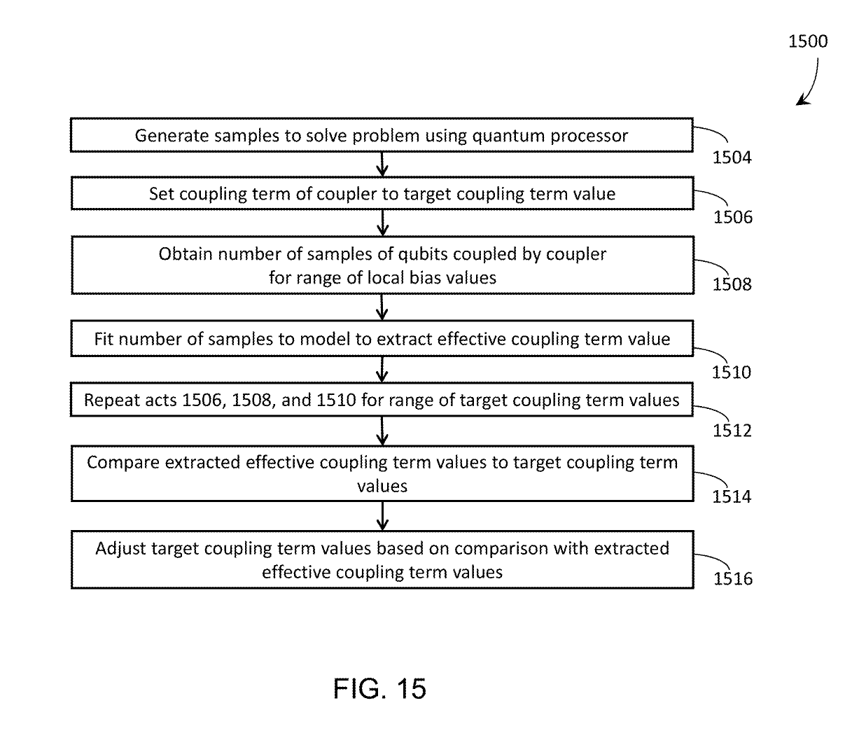

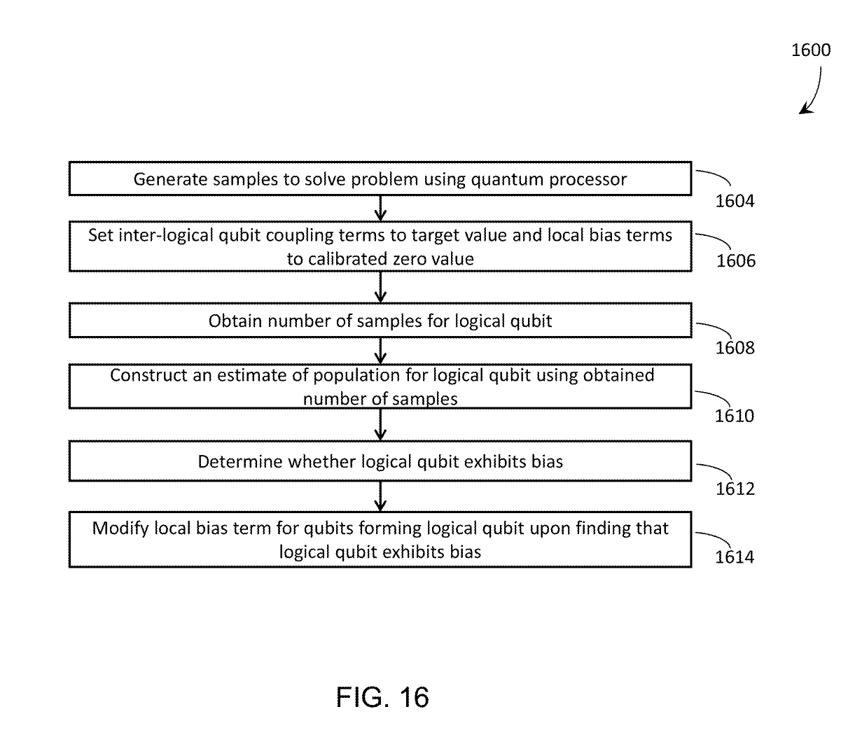

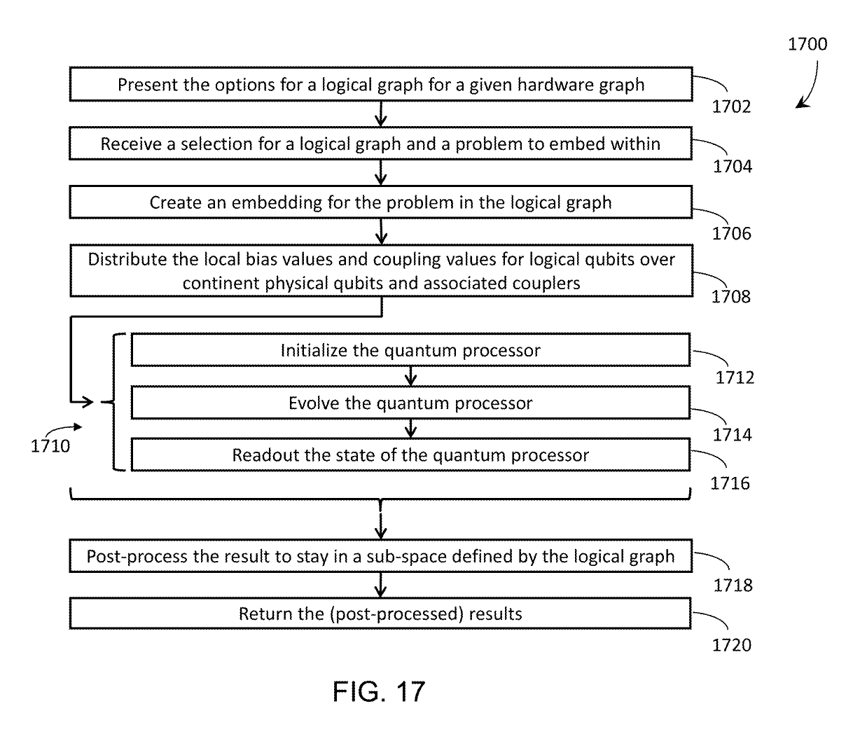

This disclosure includes designs, layouts, and architectures for quantum processors comprising qubits and couplers, and techniques for operating the same. FIG. 1 includes a hybrid computer including a quantum processor. FIGS. 2-7 include examples of portions of quantum processors. In particular, FIGS. 5-7 show embedded topologies. FIGS. 8-11 illustrate adjacency matrices for logical graphs corresponding to the topologies in FIGS. 4-7. FIG. 12 is a schematic diagram showing the process of reducing a family graphs using an embedded topology method. FIG. 13 is an additional embedded topology. FIG. 14 includes an example of a portion of quantum processor that forms what is denominated herein as an exemplary hypercube graph. FIGS. 15 and 16 include examples of methods of operation to define, in part, embedded topologies in a quantum processor. FIGS. 17, 18, and 19 include examples of methods of using quantum processor which supports embedded topologies.

FIG. 1 illustrates computing system 10 including a digital computer 105 coupled to a quantum computer 150 via an interface in accordance with the present systems, methods and devices. Shown is an exemplary digital computer 105 including a digital processor that may be used to perform classical digital processing tasks described in the present systems and methods. Those skilled in the relevant art will appreciate that the present systems and methods can be practiced with other digital computer configurations, including hand-held devices, multiprocessor systems, microprocessor-based or programmable consumer electronics, personal computers (“PCs”), network PCs, mini-computers, mainframe computers, and the like. Digital computer 105 will at times be referred to in the singular herein, but this is not intended to limit the application to a single digital computer. The present systems and methods can also be practiced in distributed computing environments, where tasks or sets of processor readable instructions are performed by remote processing devices, which are linked through a communications network. In a distributed computing environment, sets of processor readable instructions may be located in both local and remote memory storage devices.

Digital computer 105 may include at least one processor (e.g., central processor unit 110), at least one system memory 120, and at least one system bus 117 that couples various system components, including system memory 120 to central processor unit 110.

The processor may be any logic processing unit, such as one or more single or multi-core microprocessors, central processing units (“CPUs”), digital signal processors (“DSPs”), application-specific integrated circuits (“ASICs”), programmable logic units, programmable gate arrays, etc. Unless described otherwise, the construction and operation of the various blocks shown in FIG. 1 are of conventional design. As a result, such blocks need not be described in further detail herein, as they will be understood by those skilled in the relevant art.

System bus 117 can employ any known bus structures or architectures, including a memory bus with a memory controller, a peripheral bus, and a local bus. System memory 120 may include non-volatile memory such as read-only memory (“ROM”) and volatile memory such as random access memory (“RAM”) (not shown). An basic input/output system (“BIOS”) 121, which can form part of the ROM, contains basic routines that help transfer information between elements within digital computer 105, such as during startup.

Digital computer 105 may also include other non-volatile memory 115. Non-volatile memory 115 may take a variety of forms, including: a hard disk drive for reading from and writing to a hard disk, an optical disk drive for reading from and writing to removable optical disks, and/or a magnetic disk drive for reading from and writing to magnetic disks. The optical disk can be a CD-ROM or DVD, while the magnetic disk can be a magnetic floppy disk or diskette. Non-volatile memory 115 may communicate with digital processor via system bus 117 and may include appropriate interfaces or controllers 116 coupled to system bus 117. Non-volatile memory 115 may serve as long-term storage for processor readable instructions (which in some examples are arranged in program modules), data structures, and other data for digital computer 105. Although digital computer 105 has been described as employing hard disks, optical disks and/or magnetic disks, those skilled in the relevant art will appreciate that other types of non-volatile computer-readable media may be employed, such a magnetic cassettes, flash memory cards, Bernoulli cartridges, Flash, ROMs, smart cards, etc.

Various sets of processor readable instructions and/or data can be stored in system memory 120. For example, system memory 120 may store an operating system 123, and server modules 127. In some examples, server module 127 includes instruction for communicating with remote clients and scheduling use of resources including resources on the digital computer 105 and quantum computer 150. For example, a Web server application and/or Web client or browser application for permitting digital computer 105 to exchange data with sources via the Internet, corporate Intranets, or other networks, as well as with other server applications executing on server computers.

In some examples, system memory 120 may store a calculation module 131 to perform pre-processing, co-processing, and post-processing to quantum computer 150. In some examples, post-processing is done in accordance with sets of instructions in a different module. In some examples, calculation module 131 is used to request, receive, and use results from the quantum computer per methods disclosed herein. In accordance with the present systems and methods, system memory 120 may store a set of quantum computer interface modules 135 operable to interact with the quantum computer 150. In some examples, the computer interface modules 135 includes sets of processor readable instructions for a programming subsystem and/or an evolution subsystem. While shown in FIG. 1 as being stored in system memory 120, the modules shown and other data can also be stored elsewhere including in nonvolatile memory 115.

The quantum computer 150 is provided in an isolated environment (not shown) to shield the internal elements of the quantum computer from heat, magnetic field, and the like. The quantum computer includes an analog processor, An example of an analog processor is quantum processor 140 including qubits discussed herein. The qubits are controlled via qubit control system 165. The qubits are read out via a control system 160. The quantum computer also includes couplers. The couplers are controlled via coupler control system 170. In some examples of the qubit control system 165, and the coupling control system 170 are used to implement quantum annealing as described herein on quantum processor 140. Reading out the qubits creates output values or results. These results are fed to the various modules in the digital computer 105 including server modules 127, calculation module 131, or quantum computer interface modules 135, stored in nonvolatile memory 115, returned over a network or the like. In some examples, the quantum computer including components like qubit control system 165 is remotely located from the digital computer 105. For example, the digital computer 105 is located in a different room from the control system 165.

The computational system 100 may further include a logical graph set of instructions or software module 137 which defines or/and uses logical the quantum processor.

The computational system 100 may further include a quantum processor error correction set of instructions or software module 139. In some examples, the quantum processor error correction set of instructions or software module 139 performs post-processing on the results of the read-out from the quantum processor. In some examples, the quantum processor error correction set of instructions or software module 139 performs error correction or “shimming” of the quantum processor. The quantum processor error correction set of instructions or software module 139 may, for example, identify biases in quantum devices toward +1 or −1 states, and correct for such bias. The quantum processor error correction set of instructions or software module 334 may be executed by a variety of processor based devices, for instance a control system or computer associated with a particular quantum processor that is the subject of the error correction.

In some examples, the digital computer 105 can operate in a networking environment using logical connections to at least one client computer system. In some examples, the digital computer 105 is coupled via logical connections to at least one database system. These logical connections may be formed using any means of digital communication, for example, through a network, such as a local area network (“LAN”) or a wide area network (“WAN”) including, for example, the Internet. The networking environment may include wired or wireless enterprise-wide computer networks, intranets, extranets, and/or the Internet. Other examples may include other types of communication networks such as telecommunications networks, cellular networks, paging networks, and other mobile networks. The information sent or received via the logical connections may or may not be encrypted. When used in a LAN networking environment, digital computer 101 may be connected to the LAN through an adapter or network interface card (“NIC”) (communicatively linked to bus 117). When used in a WAN networking environment, digital computer 105 may include an interface and modem (not shown), or a device such as NIC, for establishing communications over the WAN. Non-networked communications may additionally, or alternatively be employed.

In accordance with some examples of the presently described systems, devices, articles, and methods, a quantum processor may be designed to perform quantum annealing and/or adiabatic quantum computation. In some examples of quantum appealing, a quantum processor may be modelled by an evolution Hamiltonian. An evolution Hamiltonian is proportional to the sum of a first term proportional to the problem Hamiltonian and a second term proportional to the disordering Hamiltonian. As previously discussed, a typical evolution may be represented by Equation (4):

H_{E}∝A(t)H_{D}+B(t)H_{P} (4)

where H_{P} is the problem Hamiltonian, disordering Hamiltonian is H_{D}, H_{E} is the evolution or instantaneous Hamiltonian, and A(t) and B(t) are examples of an evolution coefficient which controls the rate of evolution. In general, evolution coefficients vary from 0 to 1. In some embodiments, a time varying evolution coefficient is placed on the problem Hamiltonian. A common disordering Hamiltonian is:

$${H}_{D} ∝ - \frac{1}{2} {\sum }_{i = 1}^{N} {Δ}_{i} {σ}_{i}^{x} \qquad ( 5 )$$

where N represents the number of qubits, σᵢ^{x} is the Pauli x-matrix for the i^{th} qubit and Δᵢ is the single qubit tunnel splitting induced in the i^{th} qubit. Here, the σᵢ^{x} terms are examples of “off-diagonal” terms. A common problem Hamiltonian includes first component proportional to diagonal single qubit terms and a second component proportional to diagonal multi-qubit terms. The problem Hamiltonian, for example, may be of the form:

$${H}_{D} ∝ - \frac{ɛ}{2} [ {\sum }_{i = 1}^{N} {h}_{i} {σ}_{i}^{z} + {\sum }_{j > i}^{N} {J}_{ij} {σ}_{i}^{z} {σ}_{j}^{z} ] \qquad ( 6 )$$

where N represents the number of qubits, is the Pauli z-matrix for the i^{th} qubit, hᵢ is a local fields coupled into each qubit (that is, a local bias value), is a coupling value, and ε is some characteristic energy scale for H_{P}. Here, the σᵢ^{z} and σᵢ^{z}σⱼ^{z} terms are examples of “diagonal” terms. The former is a single qubit term and the latter a two qubit term. Note that the product of matrices (such as the Pauli x-matrix and Pauli z-matrix) is a tensor product. Throughout this specification, the terms “problem Hamiltonian” and “final Hamiltonian” are used interchangeably. Hamiltonians such as H_{D} and H_{P} in Equations (5) and (6), respectively, may be physically realized in a variety of different ways. A particular example is realized by an implementation of superconducting qubits.

FIG. 2 is a schematic diagram of a portion of an exemplary superconducting quantum processor 200 designed for quantum annealing (and/or adiabatic quantum computing) components which may be used to implement the present systems and devices. The portion of superconducting quantum processor 200 shown in FIG. 2 includes two superconducting qubits 201, and 202. Also shown is a tunable coupler 210 therebetween qubits 201 and 202. The coupler 210 provides a ZZ-coupling, or diagonal coupling. That is, coupler 210 provides a tunable pairwise coupling or 2-local interaction. While the portion of quantum processor 200 shown in FIG. 2 includes only two qubits 201, 202 and one coupler 210, those of skill in the art will appreciate that quantum processor 200 may include any number of qubits and any number of couplers coupling information therebetween. The qubits 201, 202 typically take the form of a physical structure which includes a closed path or loop of superconductive material, the closed path or loop interrupted by one or more Josephson junctions (e.g., compound Josephson junctions). The coupler 210 typically takes the form of a physical structure which includes a closed path or loop of superconductive material, with structures or portions proximate the respective qubits which the coupler communicatively couples, and one or more Josephson junctions interposed in a path into and/or out of the closed path or loop.

The portion of quantum processor 200 shown in FIG. 2 may be implemented to physically realize adiabatic quantum computing and/or quantum annealing. Quantum processor 200 includes a plurality of interfaces 221-225 that are used to configure and control the state of quantum processor 200. Each of interfaces 221-225 may be realized by a respective inductive coupling structure, as illustrated, as part of a programming subsystem and/or an evolution subsystem. Such a programming subsystem and/or evolution subsystem may be separate from quantum processor 200, or it may be included locally (i.e., on-chip with quantum processor 200) as described in, for example, U.S. Pat. Nos. 7,876,248; and 8,035,540.

In the operation of quantum processor 200, interfaces 221 and 224 may each be used to couple a flux signal into a respective compound Josephson junction 231 and 232 of qubits 201 and 202, thereby realizing the Δᵢ terms in the system Hamiltonian. This coupling provides the off-diagonal o^{x} terms of the Hamiltonian described by Equation (5) and these flux signals are examples of “disordering signals.” Similarly, interfaces 222 and 223 may each be used to apply a flux signal into a respective qubit loop of qubits 201 and 202, thereby realizing the local biases, or the hᵢ terms in the system Hamiltonian. This coupling provides the diagonal σ^{z} terms of Equation (6). Furthermore, interface 225 may be used to couple a flux signal into coupler 210, thereby realizing the Jᵢⱼ term(s) in the system Hamiltonian. This coupling provides the diagonal o^{z}ᵢo^{z}ⱼ terms of Equation (6). In FIG. 2, the contribution of each of interfaces 221-225 to the system Hamiltonian is indicated in boxes 221a-225a, respectively. As shown, in the example of FIG. 2, the boxes 221a-225a are elements of time varying Hamiltonian for adiabatic quantum computing and/or quantum annealing.

Throughout this specification and the appended claims, the term “quantum processor” is used to generally describe a collection of physical qubits (e.g., qubits 201 and 202) and couplers (e.g., coupler 210). The physical qubits 201 and 202 and the couplers 210 are referred to as the “programmable elements” of the quantum processor 200 and their corresponding parameters (e.g., the qubit hᵢ values and the coupler Jᵢⱼ values) are referred to as the “programmable parameters” of the quantum processor. In the context of a quantum processor, the term “programming subsystem” is used to generally describe the interfaces (e.g., “programming interfaces” 222, 223, and 225) used to apply the programmable parameters (e.g., the hᵢ and Jᵢⱼ terms) to the programmable elements of the quantum processor 200 and other associated control circuitry and/or instructions. As previously described, the programming interfaces of the programming subsystem may communicate with other subsystems which may be separate from the quantum processor or may be included locally on the processor. As described in more detail later, the programming subsystem may be configured to receive programming instructions in a machine language of the quantum processor and execute the programming instructions to program the programmable elements in accordance with the programming instructions. Similarly, in the context of a quantum processor, the term “evolution subsystem” is used to generally describe the interfaces (e.g., “evolution interfaces” 221 and 224) used to evolve the programmable elements of the quantum processor 200 and other associated control circuitry and/or instructions. For example, the evolution subsystem may include annealing signal lines and their corresponding interfaces (221, 224) to the qubits (201, 202).

Quantum processor 200 also includes readout devices 251 and 252, where readout device 251 is associated with qubit 201 and readout device 252 is associated with qubit 202. In the example shown in FIG. 2, each of readout devices 251 and 252 includes a DC-SQUID inductively coupled to the corresponding qubit 201 and 202. In the context of quantum processor 200, the term “readout subsystem” is used to generally describe the readout devices 251, 252 used to read out the final states of the qubits (e.g., qubits 201 and 202) in the quantum processor to produce a bit string. The readout subsystem may also include other elements, such as routing circuitry (e.g., latching elements, a shift register, or a multiplexer circuit) and/or may be arranged in alternative configurations (e.g., an XY-addressable array, an XYZ-addressable array, etc.). Qubit readout may also be performed using alternative circuits, such as that described in PCT Patent Publication WO2012064974.

While FIG. 2 illustrates only two physical qubits 201, 202, one coupler 210, and two readout devices 251, 252, a quantum processor (e.g., processor 200) may employ any number of qubits, couplers, and/or readout devices, including a larger number (e.g., hundreds, thousands or more) of qubits, couplers and/or readout devices. The application of the teachings herein to processors with a different (e.g., larger) number of computational components should be readily apparent to those of ordinary skill in the art.

Examples of superconducting qubits include superconducting flux qubits, superconducting charge qubits, and the like. In a superconducting flux qubit, the Josephson energy dominates or is equal to the charging energy. In a charge qubit, it is the reverse. Examples of flux qubits that may be used include rf-SQUIDs, which include a superconducting loop interrupted by one Josephson junction, persistent current qubits, which include a superconducting loop interrupted by three Josephson junctions, and the like. See, examples of rf-SQUID qubits in Bocko, et al., 1997, IEEE Trans. on Appl. Supercond. 7, 3638; Friedman, et al., 2000, Nature 406, 43; and Harris, et al., 2010, Phys. Rev. B 81, 134510; or persistent current qubits, Mooij et al., 1999, Science 285, 1036; and Orlando et al., 1999, Phys. Rev. B 60, 15398. In addition, hybrid charge-phase qubits, where the energies are equal, may also be used. Further details of superconducting qubits may be found in Makhlin, et al., 2001, Rev. Mod. Phys. 73, 357; Devoret et al., 2004, arXiv:cond-mat/0411174; Zagoskin and Blais, 2007, Physics in Canada 63, 215; Clarke and Wilhelm, 2008, Nature 453, 1031; Martinis, 2009, Quantum Inf. Process. 8, 81; and Devoret and Schoelkopf, 2013, Science 339, 1169. In some examples, the qubits and couplers are controlled by on-chip circuitry. Examples of on-chip control circuitry can be found in U.S. Pat. Nos. 7,876,248; 7,843,209; 8,018,244; 8,098,179; 8,169,231; and U.S. Patent Publication 2012-0094838.

The qubits and coupling devices in a quantum processor may be arranged into an architecture such that a certain number of qubits may be laid out into a unit cell of qubits (hereinafter, “unit cell”). A unit cell is a repeated sub-portion of a quantum processor architecture comprising qubits and coupling devices. Therefore, a plurality of unit cells tiled over an area of a quantum processor produces a certain quantum processor architecture.

Each qubit in a unit cell may be included in only one unit cell such that no qubit may be included in multiple unit cells and no qubit may be shared among multiple unit cells. New quantum processor architectures according to the present systems and devices may employ different physical arrangements with respect to known arrangements, such as those described in U.S. Pat. No. 8,421,053. As used herein and in the claims, the term “cross,” and variants thereof such as “crosses” or “crossing,” includes “overlie,” “underlie,” and “overlap”. Thus, “crosses” includes, for example, the situation where an outline of a portion of a first qubit on one layer or substrate is projected, for example perpendicularly, from that portion, layer or substrate and the projection intersects an outline of a respective portion of a second qubit on another layer or substrate. A unit cell may comprise of at least four qubits.

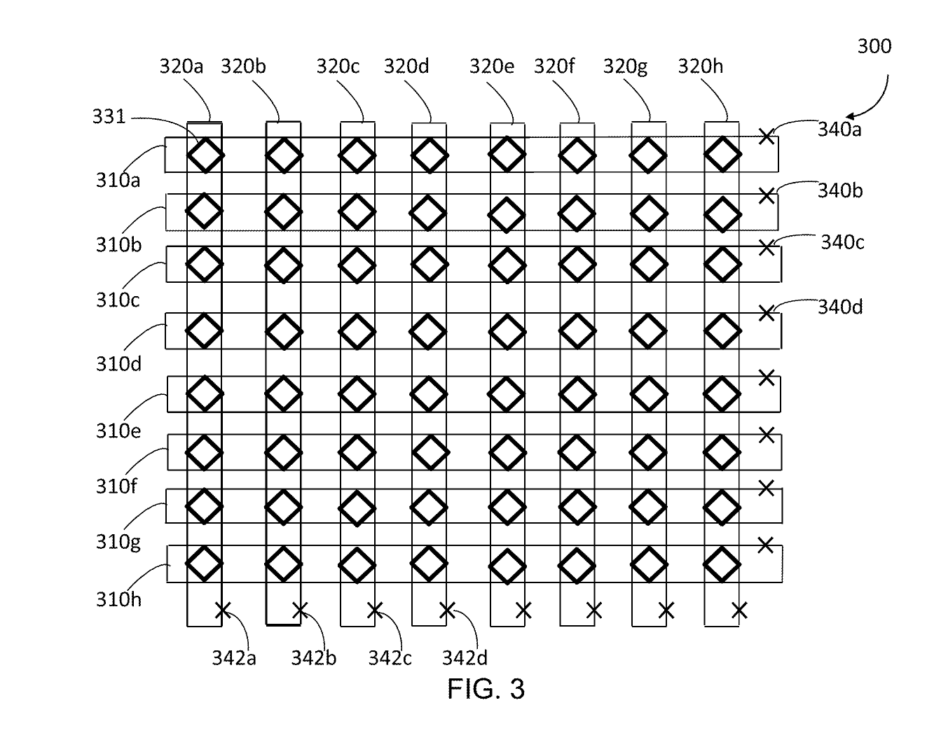

FIG. 3 shows an exemplary unit cell, or sub-topology, 300 forming the basis of a quantum processor architecture in accordance with the present systems and devices. Unit cell 300 includes a first set of qubits 310a-310h (collectively 310, only three called out in FIG. 3) and a second set of qubits 320a-320h (collectively 320, only three called out in FIG. 3). While each set is illustrated as having eight qubits, such is not limiting. In other implementations, each set of qubits in a unit cell may have a larger or smaller number of qubits, and the number of qubits in the second set does not need to equal the number of qubits in the first set. In some examples, the unit cell 300 is bi-partite. The coupler such as coupler 331 (only one called out in FIG. 3) provide tunable coupling between the first set of qubit 310 and the second set of qubits 320. The couplers do not provide tunable couplings within the first or the second set of qubits. The unit cell 300 is non-planar in that various structures may lie on each of a number of substrate planes or layers of a multi-layer substrate. For example, qubits 310 of the first set of qubits may principally reside on a first plane or layer, qubits 320 of the first set of qubits may principally reside on a second plane or layer, and couplers 331 may principally reside on a third plane or layer, for instance between the first and the second planes or layers.

The qubits 310 of the first set each have a respective longitudinal or major axis along which the superconductive paths or loops of the respective qubits 310 of the first set extend in a generally lengthwise direction of the qubit. Likewise, the qubits 320 of the second set each have a respective longitudinal or major axis long which the superconductive paths or loops of the qubits 320 of the second set extend in a lengthwise direction of the qubit. The qubits 310 of the first set have loops that are predominately or essentially parallel with one another, with the respective longitudinal or major axes at least nominally parallel to each other. The qubits 320 of the second set have loops that are predominately or essentially parallel with one another, with the respective longitudinal or major axes. Qubits 310, 320 may be superconducting qubits. Each qubit 310a-310h may be a respective loop of superconducting material where at least a first portion of each loop of superconducting material is elongated along a respective major or longitudinal axis that extends along the horizontal axis in the plane of the drawing sheet of FIG. 3. Each qubit 310a-310h is interrupted by at least one respective Josephson junction 340a-340d (only Josephson junctions 340a-340d of respective qubits 310a-310d are called out in FIG. 3 to reduce clutter).

At least the first portion of each of horizontal qubits are laid out substantially parallel to one another (i.e., respective major or longitudinal axes parallel to one another, and illustrated as parallel to the horizontal axis). In some examples, the first portion is a majority each of horizontal qubit. At least the first portion of each of vertical qubits 320 are laid out substantially parallel to one another (i.e., respective major or longitudinal axes parallel to one another, and illustrated as parallel to the vertical axis of the drawing sheet of FIG. 3). In some examples, the first portion is a majority each of vertical qubit. The major or longitudinal axes of the horizontal qubits 310 are substantially perpendicular to the major or longitudinal axes of the vertical qubits 320. Each of horizontal qubits 310 are in a first set of qubits and each of vertical qubits 320 are in a second set of qubits.

Unit cell 300 includes couplers. In some example, the unit cell includes a first set of intra-cell couplers which provides for communicative coupling between qubits within the unit cell. In some examples, each coupler in the first set of intra-cell couplers may be positioned proximate a respective point where a qubit in the first set of qubits (e.g., 310) crosses a qubit in the second set of qubits (e.g., 320). A coupler in the first set of intra-cell couplers provides controllable communicative coupling between the qubit in the first set of qubits and the qubit in the second set of qubits within the unit cell 300. An example of a coupler is coupler 331 located proximate to the intersection of qubit 310a and qubit 320a.

Some problems may be solved by embedding the problem into a quantum processor that is well designed for embedding the particular problem. For instance, it may be advantageous to employ a fixed quantum processor architecture that is different or modified from the fixed quantum processor architecture described in, for example U.S. Pat. No. 8,421,053. Such different or modified architecture may, for instance, allow better embedding and/or solution of certain problems. A problem defines a problem graph, G_{P}. In a problem graph, the nodes are variables and the edges are the pairwise interactions between variables. A problem graph G_{P} can be embedded in a logical graph, G_{L}. In a logical graph, each node represents a logical qubit, and each edge represents a tunable coupler for coupling a first logical qubits to a second logical qubit. Using an embedded topology method the logical graph G_{L} can be defined in a working graph, G_{W}. A working graph G_{W} is the set of working qubits and couplers on a hardware graph, G_{H} of a quantum processor. This can be expressed as:

G_{P}≤_{E}G_{L}≤_{ET}G_{W}≤_{C}G_{H} (7)

Where E is an embedding method, ET is an embedded topology method, and C is a calibration method. The relationship between problem graph, working graph, and hardware graph is further described in U.S. provisional patent application Ser. No. 61/983,370 filed 2014 Apr. 23.

U.S. Pat. No. 8,421,053 describes a quantum processor with qubits laid out into an architecture of unit cells including bipartite graphs, such as, K_{4,4}. In such an example, each qubit may communicatively couple to at least four other qubits. Some qubits in the architecture may have a physical connectivity of six. Depending on the available number of qubits and their interaction, problems of various sizes may be embedded into the quantum processor.

FIG. 4 shows a qubit graph 400 illustrating the interconnections realized between the qubits in quantum processor architecture 300 from FIG. 3. Graph 400 also includes vertices (e.g., 404) and edges (e.g., 406, 408). As shown herein, each vertex is a black dot each vertex also corresponds to a qubit. Each diamond shaped sub-graph, for example 402a, is a unit cell (or sub-topology) including a bi-partite graph of type and size K_{4,4} (i.e., an 4-by-4 unit cell).

Only unit cells 402a, 402b, 402c, 402d, and 402e are called out in FIG. 4 to reduce clutter. Each unit cell, such as 402a, 402b, 402c, 402d, and 402e, may represent a unit cell such as unit cell 300, the unit cells from U.S. Pat. No. 8,421,053, and the like. The lines in FIG. 4 are potential couplings representing intra-cell couplers and inter-cell couplers that may be established between qubits in the same unit cell or adjacent unit cells, respectively. Intra-cell couplings (e.g., 406) are represented with diagonal lines. Inter-cell couplings (e.g., 408) may be established between horizontally adjacent unit cells, and/or vertically adjacent unit cells and are represented with horizontal and vertical lines. As illustrated, unit cell 402a is positioned immediately next to unit cell 402b in a horizontal direction with no other unit cells in between, thereby making unit cells 402a and 402b horizontally adjacent. Unit cell 402a positioned immediately next to unit cell 402e in a vertical direction with no other unit cells in between, thereby making unit cells 402b and 402c vertically adjacent. As shown in quantum processor architecture 400, a unit cell may interact with four other unit cells placed horizontally adjacent, or vertically adjacent by inter-cell coupling, except for those unit cells located at the peripheries of quantum processor architecture 400, which may have fewer adjacent unit cells. The inter-cell couplings marked by couplings 412 and couplings 414 represent further couplings to unit cells not included in FIG. 4.

Those of skill in the art will appreciate that this assignment of vertical and horizontal directions is arbitrary, used as a convenient notation, and not intended to limit the scope of the present systems and devices in any way. It will also be appreciated that the arrangement of inter-cell couplings as horizontal and vertical lines and the intra-cell couplings as diagonal lines is a convention.

FIG. 5 is a diagram illustrating a qubit graph 500. The qubit graph 500 is the result of an embedded topology method and includes an embedded topology for the qubits in a quantum processor. FIG. 5 includes unit cells, intra-cell couplers, and inter-cell couplers. For example, the unit cells include 402a, 402b, and 402e. Graph 500 also includes vertices (e.g., 404a, 404b) and edges (e.g., 406, 408, 502a, 502b, 502c). As shown herein, each vertex is a black dot each vertex also corresponds to a qubit. Each diamond shaped sub-graph, for example 402a, is a unit cell including a bi-partite graph of type and size K_{4,4}.

FIG. 5 includes couplings defined by different coupler values that create new logical qubits. The logical qubits have different properties to physical qubits. These properties include different connectivity for the logical qubit compared to the underlying physical qubit. An example of a physical qubit is qubit 404a. In some examples, there are two types of couplers between physical qubits. A first set of couplers are the programmable couplers discussed herein, which are used to embed a particular problem, for example at a runtime. An example of a coupler in the first set of couplers is a pairwise coupling between two qubits controlled by an interface, for example, interface 225 of FIG. 2, providing a programmable pairwise coupling. A second set of couplers are placed into a desired state before the embedding of a problem, for example before a runtime or even before calibration, imposing a logical graph on the hardware graph of the processor, into which logical graph a problem may be embedded. These couplers may for convenience be denominated interchangeably as predefined fixed couplers, intra-logical qubit couplers, or logical graph implementing couplers, the states of those couplers being defined before the embedding of a problem to impose or implement a logical graph on the hardware graph of the quantum processor. An example of predefined fixed coupler is coupling 502e coupling qubit 404a and qubit 404b in graph 500.

A hybrid computer fixes the intra-logical qubit couplers in a predefined state (i.e., a state defined by a desired logical graph into which a problem will be embedded). This gives a fixed coupling value associated with the underlying coupler. In some examples, the intra-logical qubit couplers are fixed at calibration time. In some examples, the intra-logical qubit couplers are fixed after calibration and prior to run-time. An example of a fixed coupling value is a ferromagnetic coupling. In some example, the fixed coupling value is a strong ferromagnetic coupling. A strong ferromagnetic coupling is a setting on a coupler that is in magnitude greater than a setting on a coupler for an antiferromagnetic coupling. In some example, the fixed coupling value has a magnitude of twice the magnitude of the energy of an antiferromagnetic coupling. In some example, the fixed coupling value is between 1.5 and 4 times the energy of an antiferromagnetic coupling. Ferromagnetic and antiferromagnetic couplings differ by a sign. In some examples, the intra-logical qubit couplers are fixed for the duration of an initialization, anneal, and readout cycle. In some examples, the intra-logical qubit couplers are fixed to the same value over a plurality of initialization, anneal, and readout cycles.

The energy scale for specifying a problem Hamiltonian on a quantum processor is given by M_{AFM}Iₚ² where M_{AFM} is the anti-ferromagnetic mutual inductance between two superconducting devices communicatively coupled by a coupler such as two communicatively coupled qubits and Iₚ is the average persistent current of the two superconducting devices. It is desired to increase this energy scale to improve the performance of the quantum processor. However, inductive couplers have an upper-limit to the mutual inductance between two communicatively coupled superconducting devices which is set by the coupler inductance and the device-to-coupler mutual inductance. The anti-ferromagnetic mutual inductance between two communicatively coupled superconducting devices is given by:

M_{AFM}=M₁M₂X_{AFM} (8)

where M₁ is the mutual inductance between the first superconducting device and the coupler, M₂ is the mutual inductance between the second superconducting device and the coupler, and X_{AFM} is the susceptibility of the coupler (i.e., how strongly the coupler couples the two superconducting devices together). The susceptibility of a coupler is set by a flux bias of the coupler given by ϕ_{co}. Increasing the critical current of the coupler will increase X_{AFM} to an upper limit of 1/L_{co} where L_{co} denotes the inductance of the coupler. Therefore, by increasing the persistent current of the couplers in a quantum processor by a large factor (e.g., more than 10 times the persistent current), X_{AFM} can be almost doubled. However, increasing the persistent current of a coupler increases the coupler's screening parameter or beta (a convenience parameter representing the behavior of a superconducting loop such as a qubit or coupler that is used for modeling purposes). The beta (β) of a device is given by:

$$β = \frac{{2}_{TT} {L}_{X} {I}_{C}}{{φ}_{0}} \qquad ( 9 )$$

where ϕ₀ is the flux quantum of the superconducting loop, and L_{X} is the inductance of a device labeled X. For example, L_{CO} would be for a coupler and L_{QU} would be for a qubit. Increasing coupler beta increases the slope of the coupler susceptibility in the ferromagnetic region. Therefore, the coupler critical current cannot be increased by much without sacrificing the precision to which ferromagnetic/anti-ferromagnetic couplings can be specified.

In some examples, the predefined fixed couplers are set using on-chip control circuitry. For example, a digital coupling value can be supplied to a digital-to-analog converter that converts the digital value into an analog value. In the example of coupler 210 the coupler is mediated by a flux. A corresponding digital-to-analog converter could provide a flux bias for mediation the coupler.

These intra-logical qubit couplers (i.e., couplers having states set to realize a logical graph into which to embed a problem) define chains of qubits. An example of a chain of length two is intra-logical qubit coupler 502e coupling qubit 404a and qubit 404b. These chains of qubits define or form logical qubits. Ferromagnetically coupled chains of qubits are a useful technique for operating quantum processor. Ferromagnetically coupled chains of qubits can be used, for example, to mediate long range interactions across a topology. The rationale behind this approach is that by providing sufficiently strong ferromagnetic coupling between qubits in a chain the spin states of those qubits will remain locked parallel and consequently the entire chain of qubits may be treated effectively as a single qubit. A ferromagnetically coupled chain of qubits becomes an approximate 2-level system since a state of the ferromagnetically coupled chain has been restricted to reside within that portion of Hilbert space that is spanned by the two ferromagnetically aligned spin states. Each of the physical qubits that make up a chain may have an individual connectivity, while the complete logical chain may have an effective connectivity that is related to the sum of the individual connectivities of the individual physical qubits included in the chain. For example, the connectivity of the complete logical chain is value that does not exceed the sum of the connectivities of the individual connectivities of the individual physical qubits included in the chain. For further details, see U.S. Pat. No. 8,174,305 and patent application publication number US 2015-0032993.

A hybrid computer fixes the intra-logical qubit couplers in a pre-determined state (i.e., defined by the desired logical graph). The fidelity of the pre-determined state can be ensured through shimming. In order to realize a particular using spin glass instance on quantum processor, the parameters hᵢ and Jᵢⱼ used in a problem Hamiltonian may need to be translated into flux biases that are to be applied to devices on chip. The translation process may involve inverting a calibrated model of device response versus flux bias in order to determine the required bias. Systemic errors (e.g., in the calibrated qubit persistent current) or time dependent fluctuations (e.g., low frequency noise, 1/f noise, pink noise, electronics drift) may introduce errors in the representation of the problem Hamiltonian.

Implementations described herein, at FIGS. 15 and 16, provide a procedure to correct or “shim” the calibration of a quantum processor to correct or reduce these errors over extended processor operation. In particular, the procedure provides chains that are less susceptible to error. The procedure can be run on any logical qubit. In practice, any two adjacent qubits in the working graph of a quantum can form a logical qubit. However, by identifying only a sub-set of logical qubits from the set of possible logical qubits the task of shimming is reduced in complexity.

Graph 500 includes multiple examples of intra-logical qubit couplers. One example, is coupler 502e coupling qubit 404a and 404b in graph 500. Also included are intra-logical qubit couplers 502a, 502b, 502c, 502d, and 502e, and 502f. As shown in graph 500, a solid line represents an intra-logical qubit coupler. Collectively a plurality of intra-logical qubit coupler are denoted 520. In viewing the graph 500 the repetition of the intra-logical qubit couplers 502a, 502b, 502c, 502d, and 502e, and 502f in the remainder of the graph is evident. In some examples a more complicated stagger is used, see for example, FIG. 13 and associated description. In some examples, the predefined fixed coupling are set in a strong ferromagnetic coupling value. In some examples, the predefined fixed couplers are controlled by on-chip circuitry. The on-chip circuitry sets biases the coupler to a strong ferromagnetic state coupling value.

Graph 500 includes inter-logical qubit couplers that are tunable couplings between logical qubits. In FIG. 5 the couplers that provide tunable couplings are intra-cell and inter-cell couplers denoted by dashed lines. In graph 500, the degree of a physical qubit, number of incident couplers, remains unchanged from graph 400. The degree of a logical qubit formed by two physical qubits now is about 10. That is, for each logical qubit in graph 500 away from the peripheries of graph 500 there are a maximum of 10 incident dotted lines. In FIG. 5, for the logical qubits defined by a horizontal, or a vertical, predefined fixed coupling, the degree is 10. For the logical qubits defined by a diagonal predefined fixed coupling, the degree is 9, as the there is a redundant couplers between logical qubits. The identification of logical qubits by horizontal, vertical, or diagonal is for the purposes of better identify features of the graph but different orientations would support the same concepts and convenience would suggest a relabeling of the logical qubits. Graph 500 is non-planar. Graph 500 as defined by the physical qubits as nodes of the graph is non-planar. It includes as a minor the complete graph K₅, or the complete bipartite graph K_{3,3}. For a pair of graphs G and H, a graph H is a minor of a graph G if a copy of H can be obtained from G via the application of zero or more operations selected from the group consisting of: node deletion, edge deletion, and edge contraction. Graph 500 redefined by the logical qubits as nodes of the graph, and the inter-logical qubit couplers, that provide tunable couplings, as edges of the graph is also non-planar. For example, physical qubits 404a and 404b and coupler 502e, for one logical qubit. The edges indecent on the logical qubits are edges of the graph.

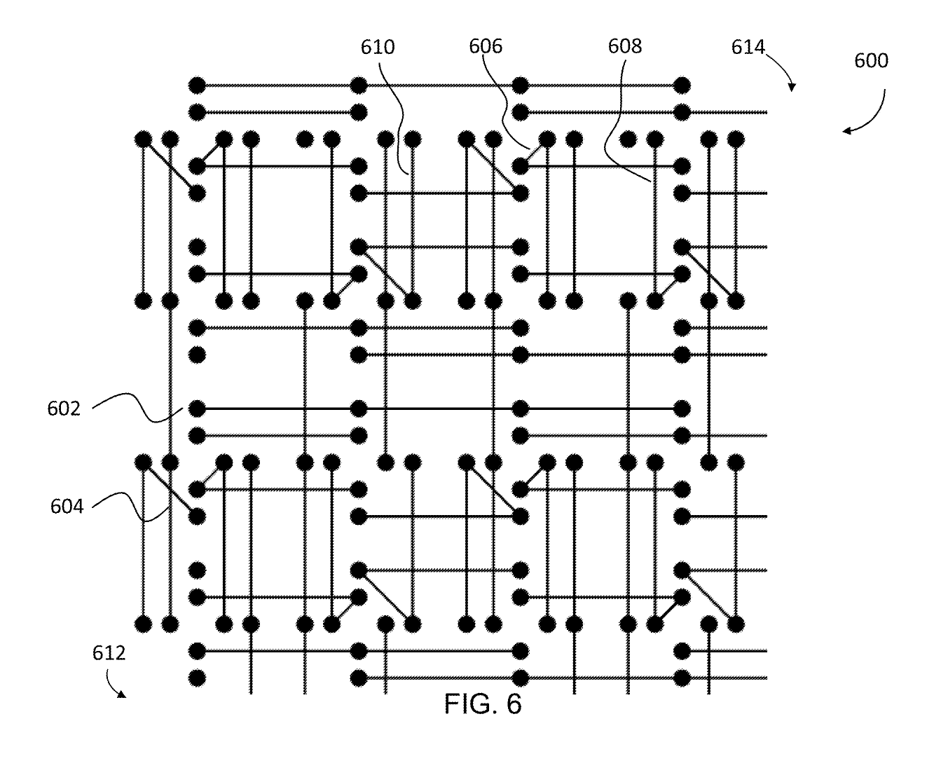

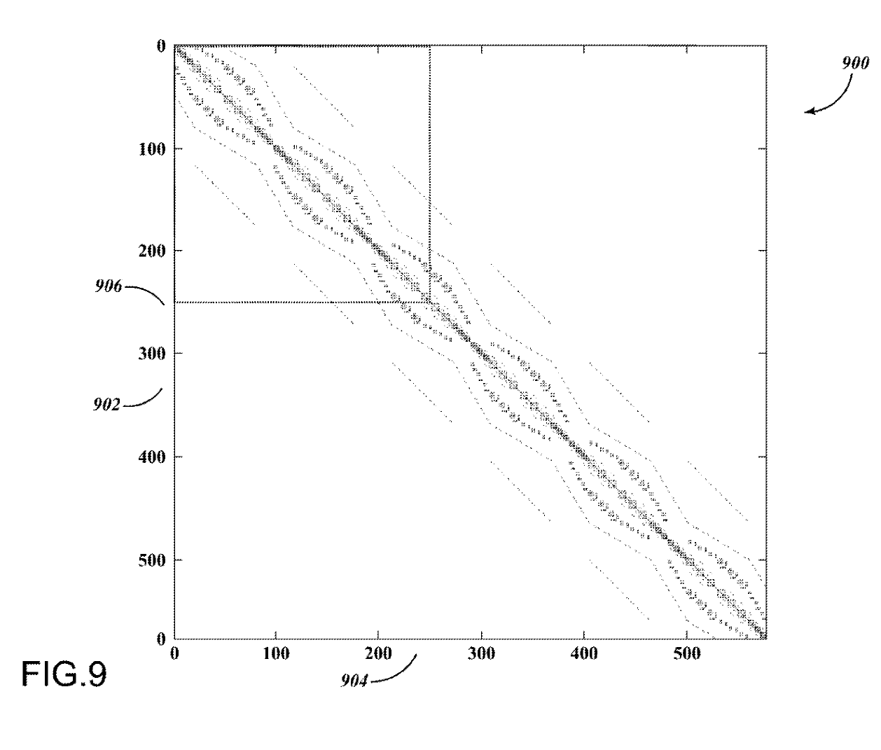

Graph 500 is an example of a regular embedded topology. An embedded topology is a minor embedding in a graph. In some examples, the minor embedding creates a graph with a different topology (or connectivity). FIG. 9 is an adjacency matrix which shows the topology for graph 500. A minor embedding is regular in two ways, one of the ways which is being homogenous. A regular embedded topology is homogenous when the qubit chains that create the embedded topology, for example, qubits 404a and 404b and coupler 502e, are all of the same length. The other one of the ways is when the embedded topology has regularity of position of the chains. A regular embedded topology includes qubit chains in given pattern over the topology. Within the pattern there are chains of different shape with their own sub-pattern. Graph 500 is an example of a regular embedded topology with chain length two. See FIGS. 6,7, and 13 for further examples with the same and other chain lengths.

FIG. 6 is a diagram illustrating a graph 600 that includes an embedded topology for the qubits in a quantum processor architecture. FIG. 6 includes qubits arranged in unit cells, inter-logical qubit couplers (tunable couplers), and intra-logical qubit couplers. As shown herein, each vertex is a black dot and each vertex corresponds to a qubit. Each diamond shaped sub-graph is a unit cell including a bi-partite graph of type and size K_{4,4}. Each solid line is an intra-logical qubit coupler. These intra-logical qubit couplers define chains of qubits, e.g., 602. These chains of qubits define logical qubits. For reasons of clarity, the available inter-logical qubit couplers are not illustrated in FIG. 6 but follow the pattern shown in graphs 400 and 500. The graph 600 continues to unseen qubit in the vertical direction 612 and horizontal direction 614.

Graph 600 includes a plurality of chains. For example, chain 602 is a horizontal chain. Chain 604 is a vertical chain. Chains 606 and 608 cross but are two separable chains of length four. Chain 610 is a different shape to chains 606 and 608. The chains of different shapes have their own sub-pattern in graph 600.

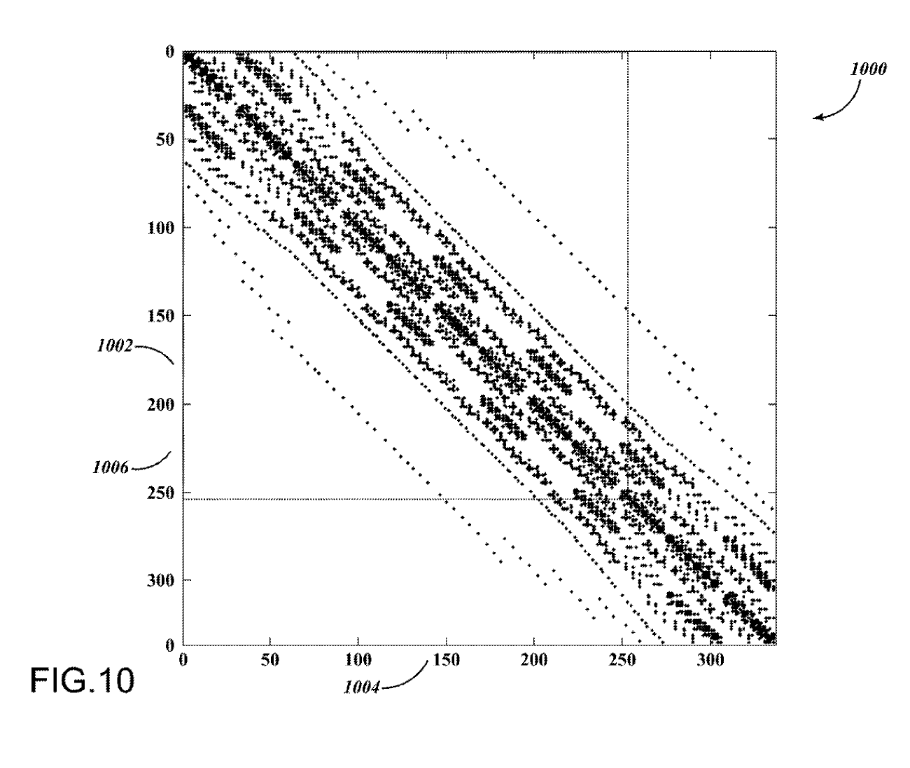

Graph 600 shares some properties with graph 500. Graph 600 is non-planar. Graph 600 is a regular embedded topology. There are some differences. In graph 600, the chains that are away from the periphery are of length four. Graph 600 is one example of how create a regular embedded topology from graph 400 using chains of length four. The adjacency matrix for the logical graph created by the topological embedding shown in FIG. 6 is shown in FIG. 10.

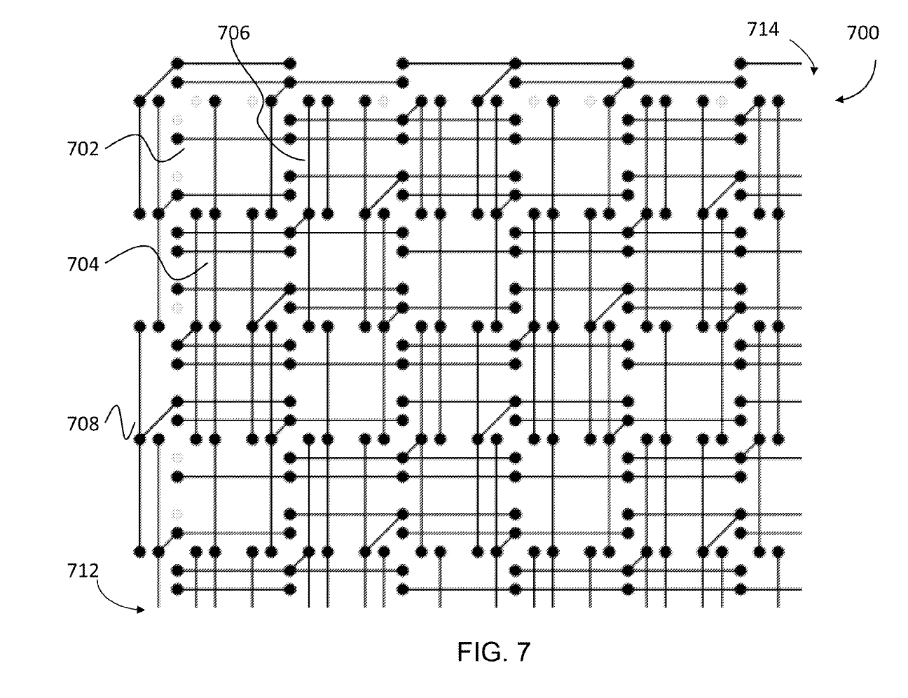

FIG. 7 is a diagram illustrating a graph 700 that includes an embedded topology for the qubits in a quantum processor architecture. FIG. 7 includes qubits arranged in unit cells and intra-logical qubit couplers. Not shown are the available couplers not used to create the embedded topology in graph 700. As shown herein, each vertex is a black dot each vertex also corresponds to a qubit. The solid lines are intra-logical qubit couplers. These intra-logical qubit couplers define chain of qubits, e.g., 702. These chains of qubits define logical qubits. The graph 700 continues to unseen qubits in the vertical direction 712 and unseen qubits in the horizontal direction 714.

Graph 700 includes a plurality of chains of length six. For example, chain 702 is a horizontal chain. Chain 704 is a vertical chain. Chain 706 is a cross-shaped chain. Chain 708 is also a tee-shaped chain. The chains in graph 700 are trees. Some chains in graph 700 are paths. These include chains 702 and 704.

Graph 700 shares some properties with graphs 500 and 600. Graph 700, as defined by the physical qubits or the logical qubits, is non-planar. Graph 700 is a regular embedded topology. The chains of different shapes have their own sub-pattern in graph 700. There are some differences. In graph 700, the chains that are away from the periphery are of length six. Graph 700 is one example of how create a regular embedded topology from graph 400 using chains of length six.

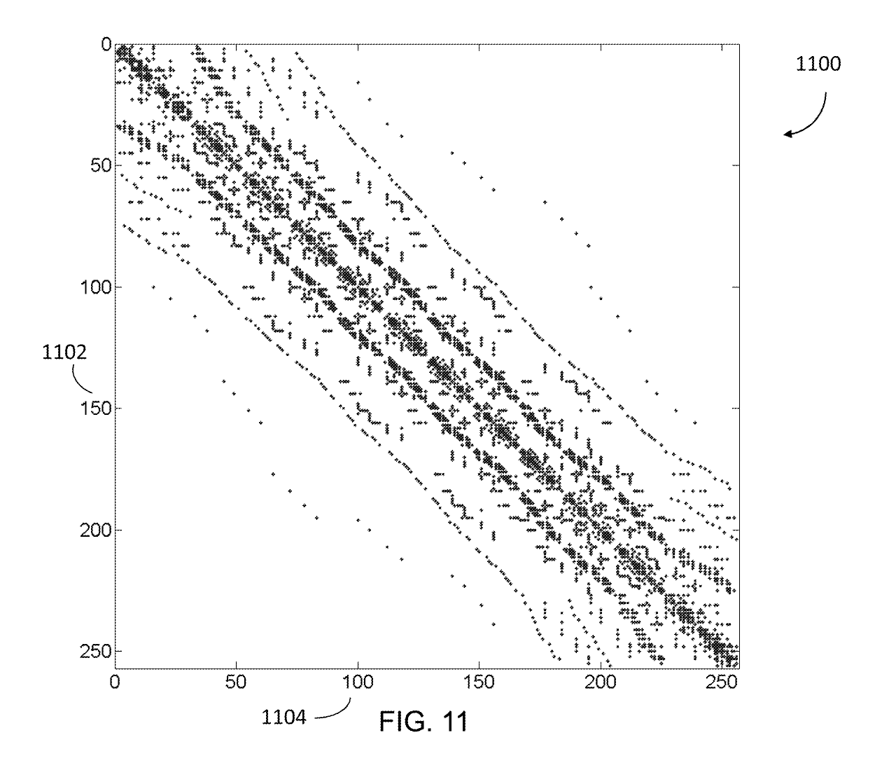

FIG. 8 is a plot illustrating an adjacency matrix 800 for qubit topology introduced in FIG. 4. An adjacency matrix a data structure and visualization technique for representing which nodes of a graph are adjacent to which other nodes. For a graph with n nodes the corresponding matrix is n×n. A non-zero entry in the non-diagonal places in the matrix show which nodes are connected to which. Matrix 800 is arranged with qubit index on axis 802 and again on axis 804. In FIG. 8, zero entries are white and non-zero entries are black. In matrix 800 the non-zero entries corresponds to the availability of a coupling between qubits. There are 1152 qubits shown in matrix 800. The number of qubits 1152 corresponds to a quantum processor with 4 plus 4 bipartite unit cell with 8 qubits per unit cell and 12-by-12 unit cells, C_{8,8,4,4}. There are about 3360 non-zero entries shown. The box 806 illustrates a fixed scale showing the number of qubits in FIG. 11.

FIG. 9 is a plot illustrating an adjacency matrix for a logical graph corresponding to the pairwise embedded topology introduced in FIG. 5. Matrix 900 is arranged with qubit index on axis 902 and again on axis 904. These qubit indices are arbitrary. However, this qubit index differs from the indices in matrix 800. In matrix 800 the index is to physical qubit. The index is to logical qubits. In FIG. 9 zero entries are white and non-zero entries are black. In matrix 900 the non-zero entries corresponds to the availability of a coupling between logical qubits. There are fewer logical qubits in matrix 900 than physical qubits in matrix 800. There are 576 logical qubits in matrix 900 compared to 1152 physical qubits in the example of matrix 800. However, the matrix 900 is less sparse than matrix 800. The connectivity of the average physical qubit in matrix 800 is about 6 while in matrix 900 the connectivity of a logical qubit is about 9. The box 906 illustrates a fixed scale showing the number of qubits in FIG. 11.

FIG. 10 is a plot illustrating an adjacency matrix 1000 for a logical graph corresponding to the embedded topology introduced in FIG. 6. The embedded topology in FIG. 6 includes chains of length four. Matrix 1000 is arranged with qubit index on axis 1002 and again on axis 1004. In matrix 1000 the indices are to logical qubits. There are fewer logical qubits in matrix 1000 than physical qubits in matrix 800 and logical qubits in matrix 900. In the example of matrix 1000 there are 336 logical qubits compared to 1152 physical qubits in the example of matrix 800. Of these 336 logical qubits, 240 are of length four and the balance are shorter. The mean length is about 3.42 physical qubits. However, the matrix is less sparse than both matrix 800 and matrix 900. The mean connectivity of a logical qubit in matrix 1000 is about 14. The box 1006 illustrates a fixed scale showing the number of qubits in FIG. 11.

FIG. 11 is plot illustrating an adjacency matrix 1100 for a logical graph corresponding to the embedded topology introduced in FIG. 7. The embedded topology in FIG. 7 includes chains of length six. Matrix 1100 is arranged with qubit index on axis 1102 and again on axis 1104. In matrix 1100 the indices are to logical qubits. There are fewer logical qubits in matrix 1100 than physical qubits in matrix 800 and logical qubits in matrices 900 and 1000. There are 256 logical qubits in matrix 1100 compared to 1152 physical qubits in the example of matrix 800. Of these 256 logical qubits, about 136 are of length six and the balance are shorter. The mean length is 4.5 physical qubits. For a larger processor an encoded topology would be less dominated by edge effects and lead to a longer mean length. However, matrix 1100 is less sparse than matrices 800, 900, and 1000. The mean connectivity of a logical qubit in matrix 1100 is about 15. For an encoded topology on a C_{24,24,4,4} the mean connectivity would be about 17 and for C_{36,36,4,4} about 18.

FIG. 12 is a schematic diagram showing self-similarity of a family of graphs under an embedded topology method. A series of graphs 1200 show the process of collapsing a family of graphs where each graph in the series is a member of the family with different parameters. The relationship between members of the family can be expressed as:

f(G_{P})⊆G_{f′(P)} (10)

where f(G_{P}) is the collapsing operation performed on graph G_{P} with parameter P, and is contained graph G_{f(P)} where f′( ) adjusts the parameter of the graph. When graphs in a family map from one member of the family to another member of the family then the graphs are said to exhibit self-similarity.

Graph 1202 is an eight-by-eight planar lattice given the label G₈. The nodes are the intersections of the edges. For example, node 1204 is one of the sixty-four nodes in the graph 1202. Under a collapsing operation groups of four nodes and four edges are contracted into one node. For example sub-graph 1206 will be collapsed into one node.

Graph 1212 is a four-by-four planar lattice given the label G₄. The graph 1212 is the output of the collapsing operation on graph 1202. The nodes are the intersections of the edges. For example, node 1214 is one of the sixteen nodes in the graph 1212. Under a further application of the collapsing operation groups of four nodes and four edges are contracted into one node. For example, sub-graph 1216 will be collapsed into one node.

Graph 1222 is a two-by-two planar lattice given the label G₂. The graph 1222 is the output of the collapsing operation on graph 1212. Under a further application of the collapsing operation 1226 the group of the four nodes and four edges of graph 1222 are contracted into one node.

Graph 1232 is a single node and given the label G₁. The graph 1232 is the output of the collapsing operation on graph 1232. Thus in series 1200 through three applications of the same mapping an eight-by-eight planar lattice is reduced to a node. This principle is useful in creating embedded topologies.

Different graphs admit different embedded topologies. Some examples of embedded topologies are show in FIGS. 5-7. Alternative embedded topologies are possible. For example, consider a graph such as graph 400 extending eight unit cells by eight unit cells where each unit cell is a bipartite four-and-four graph K_{4,4} and the unit cells are connected to vertically and horizontally adjacent unit cells. Such a graph can be labeled C_{8,8,4,4}. An embedded topology of with logical qubits of length two can be created.

FIG. 13 is a diagram illustrating a graph 1300 that includes an embedded topology for the qubits in a quantum processor architecture. FIG. 13 includes qubits arranged in unit cells, intra-logical qubit couplers, and other available couplers. As shown in FIG. 13, each vertex is a black dot each vertex also corresponds to a qubit. Each diamond shaped sub-graph is a unit cell including a bi-partite graph of type and size K_{4,4}. Each solid line is an intra-logical qubit couplers. These intra-logical qubit couplers define chains of qubits. These chains of qubits define logical qubits.

In graph 1300 the arrangement of intra-logical qubit couplers is a staggered pattern. A plurality of couplers 1302a are intra-logical qubit couplers. The plurality of couplers 1302a extend the height of the graph 1300. The plurality of couplers 1304a are available couplers. The couplers 1304a extend the height of the graph 1300. A plurality of couplers 1302b are adjacent to the couplers 1304a and are intra-logical qubit couplers. This is a 1-on-skip-1 pattern.

The 1-on-skip-1 pattern is replicated in the vertical direction. A plurality of couplers 1312a are intra-logical qubit couplers. The plurality of couplers 1312a extend the width of the graph 1300. The plurality of couplers 1314a are available couplers. A plurality of couplers 1312b follow the couplers 1304a and are intra-logical qubit couplers. This is a 1-on-skip-1 pattern in the vertical direction.

This 1-on-skip-1 pattern in both the vertical and horizontal direction converts the C_{8,8,4,4} graph to a C_{4,4,8,8} graph. An example of a C_{8,8,4,4} would be an 8 by 8 set of unit tiles each with bi-partite 4 plus 4 unit cell. A similar 2-on-skip-1 pattern converts a C_{9,9,4,4} graph to a C_{3,3,12,12} graph. A similar 3-on-skip-1 pattern converts a C_{8,8,4,4} graph to a C_{2,2,16,16} graph.

FIG. 14 is a schematic diagram of an exemplary unit cell 1400 having a hypercube graph topology forming at least a portion of a quantum processor architecture. Unit cell 1400 includes a first set of qubits 1402a-1402d (collectively 1402) and at least a second set of qubits 1404a-1404d (collectively 1404). While each set is illustrated as having four qubits, such is not limiting. In other implementations, each set of qubits in a unit cell may have a larger or smaller number of qubits, and the number of qubits in the second set does not need to equal the number of qubits in the first set. Unit cell 1400 further includes a third set of qubits 1406a-1406d (collectively 1406) and a fourth set of qubits 1408a-1408d (collectively 1408).

The qubits 1402 of the first set each have a respective longitudinal or major axis 1432 along which the superconductive paths or loops of the respective qubits 1402 of the first set extend in a lengthwise direction of the qubit. As illustrated, the path of a qubit such as qubit 1402a is a line. Likewise, the qubits 1404 of the second set each have a respective longitudinal or major axis 1404 along which the superconductive paths or loops of the qubits 1404 of the second set extend in a lengthwise direction for the qubits. The qubits 1402 of the first set have loops that are predominately or essentially parallel with one another, with the respective longitudinal or major axes at least nominally parallel to each other. The qubits 1404 of the second set have loops that are predominately or essentially parallel with one another, with the respective longitudinal or major axes. The qubits 1402 of the first set have loops that are predominately or essentially parallel with one another, with the respective longitudinal or major axes at least nominally parallel to each other.

Qubits 1402, 1404, etc., may be superconducting qubits. Each qubit 1402a-1402d may be a respective loop of superconducting material where at least a first portion of each loop of superconducting material is elongated along a respective major or longitudinal axis that extends along the horizontal axis in the plane of the drawing sheet of FIG. 14. Each qubit 1402a-1402d is interrupted by at least one respective Josephson junction (not shown to reduce clutter).

At least the first portion or a majority of each of horizontal qubits, 1402 and 1406, are laid out substantially parallel to one another (i.e., respective major or longitudinal axes parallel to one another, and illustrated as parallel to the horizontal axis). At least the first portion or a majority of each of vertical qubits, 1404 and 1408, are laid out substantially parallel to one another (i.e., respective major or longitudinal axes parallel to one another, and illustrated as parallel to the vertical axis of the drawing sheet of FIG. 14). For example, the major or longitudinal axes of the horizontal qubits 1402 are substantially perpendicular to the major or longitudinal axes of the vertical qubits 1404. Each of horizontal qubits 1402 are in a first set of qubits and each of vertical qubits 1404 are in a second set of qubits.

Unit cell 1400 includes couplers. In some examples, the unit cell includes a first set of intra-cell couplers. In some examples, each coupler in the first set of intra-cell couplers may be positioned proximate a respective point where a qubit in the first set of qubits crosses (e.g., over, under, by) a qubit in the second set of qubits. The set of intra-cell couplers 1420 is an example of the first set of intra-cell couplers for set of qubits 1402. A coupler in the first set of intra-cell couplers provides controllable communicative coupling between the qubit in the first set of qubits and the qubit in the second set of qubits. An example of a coupler is coupler 1442a located proximate to the intersection of qubit 1402a and qubit 1404a.

In some examples, the unit cell includes a second set of intra-cell couplers. In some examples, each coupler in the second set of intra-cell couplers may be positioned proximate a respective point where a qubit in a first set of qubits crosses (e.g., over, under, by) a qubit in a second set of qubits. A set of couplers 1442 is an example of the second set of intra-cell couplers. Coupler 1442a is an example of a coupler proximate to where a qubit in the first set of qubits 1402 crosses a qubit in the fourth set of qubits 1408. The set of intra-cell couplers 1444 is an example of the second set of intra-cell couplers for the set of qubits 1402 and the set of qubits 1404. A coupler in the second set of intra-cell couplers provides controllable communicative coupling between the qubit one set of qubits and the qubit in another set of qubits.

A hypercube graph is a graph that includes a number of nodes and edges. For a hypercube graph, the number of nodes, edges, and the degree of the nodes is well defined. For example, a hypercube graph of size n has 2ⁿ nodes and n*2⁽ⁿ⁻¹⁾ edges. The degree of the nodes in a hypercube graph is uniform. For each node, n edges touch the node. Where an edge touches a node, the edge is said to be incident on the node. Thus, a single parameter n can describe a hypercube graph.

Unit cell 1400 is a hypercube graph. The unit cell 1400 includes 16 nodes—the four qubits of each set of qubits 1402, 1404, 1406, and 1408. The unit cell 1400 includes 32 edges, formed from the couplers, for example sets of couplers 1420, 1442, and 1444. Each qubit is proximate to 4 couplers, so each node is touching 4 edges. Thus the unit cell 1400 is a hypercube graph of size 4.

FIG. 15 is a flow diagram showing a method 1500 of calibration correction for coupling terms (Jᵢⱼ) to increase the performance of a quantum processor in accordance with the present systems, devices, articles, and methods. The method 1500 may be implemented to correct for drifts in the current supplied by the electronics of a quantum processor, or small errors constructing an effective coupling terms model (“J model”) that can increase coupling term related intrinsic/control errors.

The method 1500 could be implemented by a series or set of processor-readable instructions stored on one or more nontransitory processor-readable media. Some examples of the method A00 are performed in part by a specialized device such as an adiabatic quantum computer or a quantum annealer or a system to program or otherwise control operation of an adiabatic quantum computer or a quantum annealer, for instance a computer that includes at least one digital processor. The method 1500 includes various acts, though those of skill in the art will appreciate that in alternative examples certain acts may be omitted and/or additional acts may be added. Those of skill in the art will appreciate that the illustrated order of the acts is shown for exemplary purposes only and may change in alternative examples.

The method 1500 starts, for example in response to a call from another routine or other invocation. At 1504, the computational system generates samples to solve a problem using a quantum processor. Example acts for generating a samples for a problem are described herein with reference to acts 1712-1716 of method 1700 (FIG. 17) and are not repeated here for brevity.

At 1506, for a particular coupler, the processor-based device sets the coupling term for a plurality of particular coupler to a target coupling term value (Jᵢⱼ) relative to a calibrated zero. At 1508, the processor-based device collects a number of samples from the quantum processor for a range of local bias term values hᵢ and hⱼ for the two qubits coupled by the particular coupler. For example, the range of inter-qubit couplings may be restricted to within −1 Jᵢⱼ≤+1 and local bias terms to within −1≤hᵢ≤+1. Thus, for a particular target coupling term value (e.g., Jᵢⱼ=−0.5), samples are collected for a range of hᵢ and a range of hⱼ (e.g., −1≤hᵢ, hⱼ≤+1). At 1510, the processor-based device fits statistics for the collected samples to a model (e.g., a simple thermal model) to extract an effective temperature and an effective Jᵢⱼ. Examples of a thermal model include a model that assumes the quantum processor's states follow the Boltzmann distribution at a finite temperature.

At 1512, the processor-based device repeats acts 1506, 1508 and 1510 for a range of Jᵢⱼ values (e.g., 1≤Jᵢⱼ≤+1) for the coupler to obtain a number of effective coupling term values Jij that each corresponds to a respective target coupling term value.

At 1514, the processor-based device compares the range of target coupling term values to the determined effective coupling term values. At 1516, the processor-based device adjusts the target coupling term values based on the comparison with the extracted effective coupling term values. For example, in some implementations the processor-based device may use a low order polynomial correction to “shim” or correct the coupling terms requested by a problem. With the correction in place, the processor-based device may then submit the requested problem to be solved to the quantum processor.

The method 1500 ends after 1516 until started again. For example, the method 1500 may be repeated for each coupler in a quantum processor. The method 1500 may also be called any time it is beneficial to obtain updated or “on-the-fly” calibration parameters for the quantum processor (e.g., after the quantum processor has been operating for an extended period of time after initial calibration).

Couplers that couple qubits to form a logical qubit are referred to herein as intra-logical qubit couplers, where each of the intra-logical qubit couplers has a respective coupling strength that ferromagnetically couples a respective pair of the physical qubits as a logical qubit. Couplers that couple qubits of respective logical qubits are referred to herein as inter-logical qubit couplers, where each of the inter-logical qubit couplers has a respective coupling strength that controllably couples a respective pair of physical qubits, where the physical qubits in the respective pair each belong to respective ones of two different ones of the logical qubits and wherein at least two variables from a problem are assigned to two respective logical qubits.

When inter-logical qubit couplers are tuned, an unintended flux offset may be introduced into the couplers that attach a logical qubit to other logical qubits. Infrastructure may be provided to compensate for these flux offsets, but small residual offsets may remain. In particular, when a set of qubits are connected with couplers each having a coupling strength Jij to form a logical qubit, the logical qubit may acquire an effective bias toward one of the two states in the logical subspace (e.g., toward +1 or −1).

FIG. 16 is a flow diagram showing a method 1600 for implementing a calibration correction for local bias values (hᵢ) of qubits forming a logical qubit to increase the performance of a quantum processor in accordance with the present systems, devices, articles, and methods. Specifically, the method 1600 may be implemented to compensate for the aforementioned effective bias that may be acquired by logical qubits.

The method 1600 could be implemented by a series of processor readable instructions stored on a media. Some examples of method 1600 are performed in part by a specialized device such as an adiabatic quantum computer or a quantum annealer or a system to program or otherwise control operation of an adiabatic quantum computer or a quantum annealer, for instance a computer that includes at least one digital processor. The method 1600 includes various acts, though those of skill in the art will appreciate that in alternative examples certain acts may be omitted and/or additional acts may be added. Those of skill in the art will appreciate that the illustrated order of the acts is shown for exemplary purposes only and may change in alternative examples.

The method 1600 starts, for example in response to a call or other invocation from another routine.

At 1604, the computational system generates samples to solve a problem using a quantum processor. Example acts for generating a samples for a problem are described herein with reference to acts 1712-1716 of method 1700 (Figure X) and are not repeated here for brevity.

At 1606, the processor-based device sets all of the local bias terms (hᵢ) to a calibrated zero value and all of the inter-logical qubit coupling terms (Jᵢⱼ) to a target value relative to a calibrated zero value. In some implementations, the intended target value is non-zero. The intra-logical qubit couplers may be set to a coupling strength sufficient to form logical qubits each comprising multiple qubits.

At 1608, the processor-based device collects a number of samples for the logical qubits from the quantum processor.

At 1610, the processor-based device constructs an estimate of the population of every logical qubit in the working graph of the quantum processor, and at 1612 determines whether each logical qubit exhibits a bias toward a basis state (e.g., a bias toward +1 or −1). At 1614, for each qubit in a set of qubits forming a logical qubit which is determined to exhibit a bias, the processor-based device adjusts the local bias term (hᵢ). This process may be executed iteratively until none of the logical qubits of the quantum processor exhibit a bias, or at least until some termination criteria is met (e.g., a calibration time is exceeded, a number N of calibration iterations is reached, or a maximum bias threshold is met). With the correction in place, the processor-based device may then submit the requested problem to be solved to the quantum processor.

In some implementations, the following acts are used to implement the method 1600. First, the processor-based device sets a bias adjustment value to some small amount (e.g., 0.3). The processor-based device may then sample solutions to the problem using the quantum processor with only the intra-logical couplers having non-zero values. If the logical qubit is biased in one direction or the other, the processor-based device may modify the local bias (hᵢ) on each qubit forming the logical qubit by the bias adjustment value. The processor-based device may repeat these acts for each logical qubit in the quantum process. The processor-based device may then reduce the value for the bias adjustment value (e.g., by half), and repeat the above acts for a number (e.g., seven) of iterations. The final local biases hᵢ may then be applied to the original problem to be solved using the quantum processor.

Method 1600 may terminate after 1614 until started again. For further details see U.S. patent application Ser. No. 62/040,890 filed 2014 Aug. 22.

FIG. 17 shows a method 1700 executable by circuitry to use a quantum computer with embedded topologies. For the method 1700, as with other methods taught herein, the various acts may be performed in a different order than that illustrated and described. Additionally, the methods can omit some acts, and/or employ additional acts. One or more of these acts may be performed by or via one or more circuits, for instance one or more processors (e.g., digital processors such as microprocessors, analog processor such as quantum processors, a hybrid computer including a digital processor and an analog processor). Similarly a hybrid computer may perform one or more of the acts in method 1700.

At 1702, the hybrid computer presents, within an interface, one or more options for a logical graph. In some examples, the interface includes a client interface for presentation to a user. In some examples, the interface includes an application programming interface or the like. Examples of logical graphs include the graphs 400, 500, 600, 700, 1300, and the like. In some example, the hybrid computer causes a presentation of a representation of a plurality of user selectable logical graphs. In some examples, the representation of a plurality of user selectable logical graphs includes textual representations. In some examples, the textual representations of the plurality of user selectable logical graphs is a semi-structured representation. In some example, the hybrid computer converts the textual representation of a graph into a data structure such as an adjacency matrix. See examples in FIGS. 8-11.

At 1704 the hybrid computer receives a selection for a logical graph, G_{L}. In some examples, the selection is a default logical graph. In some examples, the default is graph 400.

Also at 1704 the hybrid computer receives a problem to embedded in the logical graph. Examples of problems include integer linear programs, discrete optimization problems, constrain satisfaction problems, optimization of database queries, image recognition and others. See U.S. Pat. Nos. 7,877,333; 8,386,554; 8,032,474; 8,655,828; and 8,700,689.

At 1706 the hybrid computer creates an embedding for the problem for the logical graph, G_{L}. One method of embedding a problem, with its own problem graph, G_{P}, into a logical graph, G_{L}, is as follows. In a first stage, sets of connected subgraphs are successively generated, each set including a respective subgraph for each variable in the problem graph G_{P}. Adjacent variables in the problem graph are mapped to respective vertices in the logical graph, G_{L}. The respective vertices which are connected by at least one respective edge in the logical graph, G_{L}. In a second stage, the connected subgraphs are refined such that no vertex represents more than a single variable. See U.S. Patent application publication number US 20140250288 A1.

At 1708 the hybrid computer distributes the local bias values and the coupling values for the variables in the problem over the physical qubits and the logical qubits underlying the logical graph, G_{L}. Here the hybrid computer increases the dynamic range of the problem. Recalling a logical qubit includes two or more physical qubits, local bias values for a logical qubit could be distributed over the physical qubits in the logical qubit. For example, for a local bias value h′ᵢ for an i-th logical qubit can be distributed over one or more physical qubits included in the logical qubit. For example, the following relation may be used:

h′ᵢ=Σ_{kϵL(i)}⁽ⁱ⁾ (11)

Where hₖ⁽ⁱ⁾ is the k-th physical qubit for the i-th logical qubit, L(i). The local bias values on a logical qubit reflect an aggregate of the applied biases on the physical qubits included in the logical qubit.

There are different techniques for distributing the local bias values over the physical qubits included in the logical qubit. In some examples, the local bias is placed on one physical qubit in the logical qubit. In some examples, the local bias value is evenly distributed over all the physical qubits included in the logical qubit. That is, subject to the precision in which the local bias can be applied to a physical qubit the local bias value is spread evenly. For example, if the local bias value is in aggregate to be one and the four physical qubits are include the logical qubit then each physical qubit is biased by a value of one quarter.

In some examples, the local bias value is distributed over a sub-set of the physical qubits in the logical qubit. For example, an even distribution over all physical qubits requires that a hybrid computer specify a value below the precision to which a bias can be set, then the hybrid computer distributes the aggregate bias on a sub-set of the physical qubits in the logical qubit. Or, for example, an aggregate bias value if distributed over all physical qubits or a sub-set of the physical qubits leads to a bias value on a physical qubit that is below a threshold δ then the local bias value can be set on a sub-set of the physical qubits or a sub-set to the sub-set of physical qubits included in the logical qubit.

In some examples, the local bias is unevenly distributed over all the physical qubits in the logical qubit. In some examples, the local bias values for the physical qubits at the end of the logical qubits is greater than in the middle. In some examples, the local bias values for the physical qubits in the middle of the logical qubits is greater than the local bias values for the physical qubits in the middle of the logical qubit. In some examples, the local bias values for the physical qubits is set proportional to the likelihood the chain defining the logical qubit is going to break.

For example, for a local bias value J′ᵢⱼ for a coupling between an i-th logical qubit and a j-th logical qubit can be distributed over the physical coupler between the logical qubits. For example, the following relation may be used:

J′ᵢⱼ=Σ_{kϵL(i),lϵL(i)}Jₖₗ^{(ij)} (12)

There are different techniques for distributing the coupling values over the physical couplers between a pair of logical qubits. In some examples, the coupling value is evenly distributed over the physical couplers between a pair of logical qubits. In some examples, the coupling value is unevenly distributed over all the couplers between a pair of logical qubits. The aggregate value of the coupling values for the physical couplers equals the intended values for the coupling between the pair of logical qubits.

At 1710, the hybrid computer requests and receives a result from the quantum processor implementing the problem, for example as set out as 1712 and 1714, below.

Also at 1712 the hybrid computer initializes the quantum processor to an initial state. For example, the hybrid computer initializes in a ground state of the initial Hamiltonian. The initial Hamiltonian is selected because its ground state is accessible. The initial Hamiltonian is, during act 1712, the instant Hamiltonian of the quantum processor. An example initialization Hamiltonian includes off-diagonal single qubit terms.

At 1714, the quantum processor as described by its instant Hamiltonian is evolved toward a problem Hamiltonian, H_{P}. At 1716, the quantum processor provides a read-out. In some examples, the results of the read-out are returned from the quantum processor. In some examples, the results of the read-out are stored.

In FIG. 17 acts 1712, 1714, and 1716 are collectively referred to a single act 1710. At 1718, optionally, the hybrid computer post-processes the results of the read-out. That is the hybrid computer performs or requests another processor to perform one or more post-processing operations. In some examples, the other processor is a digital processor. Examples of the one or more post-processing operations include: a majority voting post-processing operation, a greedy descent post-processing operation, a variable clamping post-processing operation, a variable branching post-processing operation, or a local field voting post-processing operation. The hybrid computer preserves the chains if any defines the logical graph, G_{L}.

Post processing operations may be implemented on one or more of a microprocessor, a digital signal processor (DSP), a graphical processing unit (GPU), a field programmable gate array (FPGA), or other circuitry. See, U.S. patent application Ser. No. 62/040,643 filed 2014 Aug. 22. At 1720, optionally, the hybrid computer returns the results of the read-out. In some examples, the hybrid computer returns the post-processed results of the read-out.

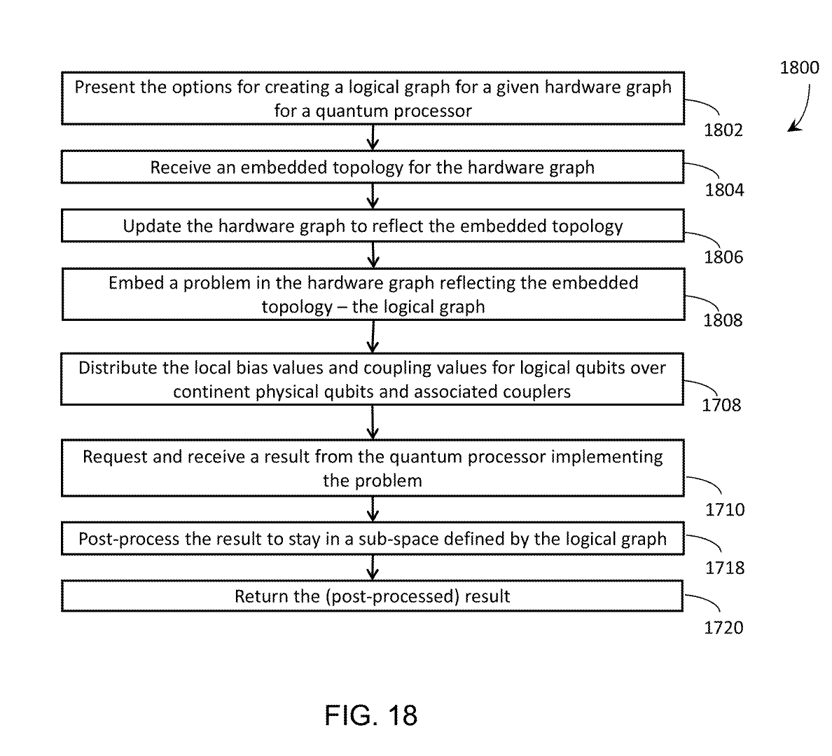

FIG. 18 shows a method 1800 executable by circuitry to use a quantum computer with embedded topologies. A hybrid computer may perform one or more of the acts in method 1800.

At 1802, the hybrid computer presents within an interface an option for creating a logical graph. In some examples, the interface includes a client interface for presentation to a user. In some examples, the interface includes an application programming interface or the like. Examples of logical graphs include the graphs 400, 500, 600, 700, 1300, and the like. For example, a user is presented with the option for creating a logical graph for a hardware graph. In some examples, the hybrid computer presents within the interface user settable parameters to specify the logical graph. For example, the user settable parameters include chain length, chain shape, and repetition pattern of chains to define logical qubits and a logical graph.

At 1804, the hybrid computer receives an embedded topology that defines a logical graph. At act 1806, the hybrid computer updates the quantum processor to define the predefined fixed couplings creating a logical graph, G_{L}.

At 1808, the hybrid computer creates an embedding for the problem for the logical graph, G_{L}.

At 1708 the hybrid computer distributes the local bias values and the coupling values for the variables in the problem over the physical qubits and the logical qubits underlying the logical graph, G_{L}. Here the hybrid computer increases the dynamic range of the problem.

At 1710 the hybrid computer requests and receives a result from the quantum processor implementing the problem. The hybrid computer initializes the quantum processor to an initial state. For example, the hybrid computer initializes the quantum processor in a ground state of the initial Hamiltonian. The quantum processor as described by its instant Hamiltonian is evolved toward a problem Hamiltonian, H_{P}. The quantum processor provides a read-out. In some examples, the results of the read-out are returned form the quantum processor. In some examples, the results of the read-out are stored.

At 1718, optionally, the hybrid computer post-processes the results of the read-out. At 1720, optionally, the hybrid computer returns the results of the read-out. In some examples, the hybrid computer returns the post-processed results of the read-out.

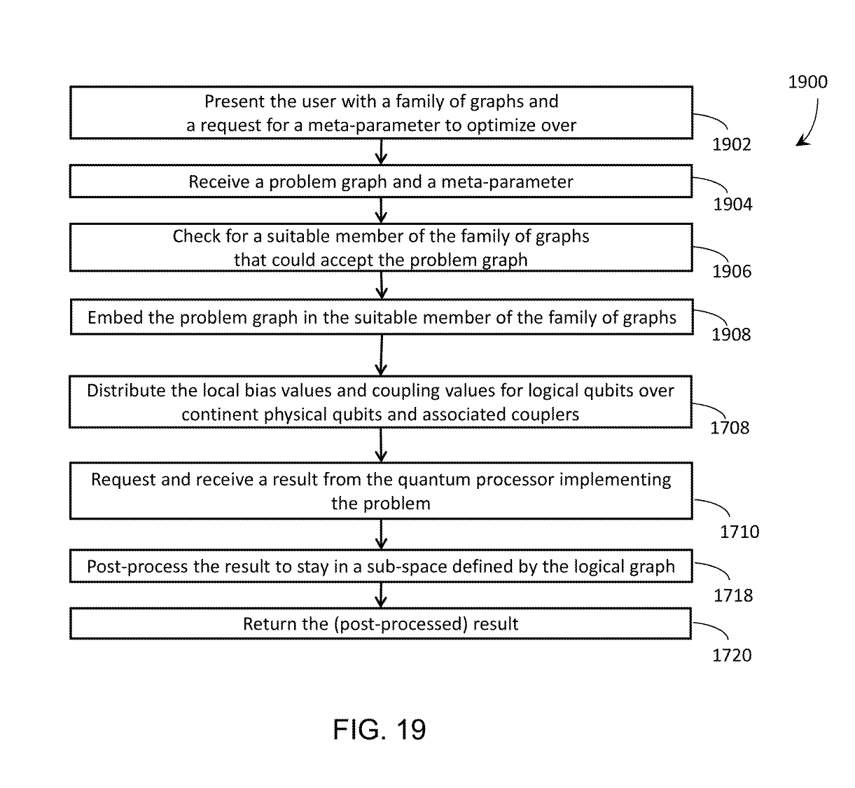

FIG. 19 shows a method 1900 executable by circuitry to use a quantum computer with embedded topologies. A hybrid computer may perform one or more of the acts in method 1900.

At 1902, the hybrid computer presents within an interface a family of graphs and a request for a meta-parameter to optimize over. In some examples, the interface includes a client interface for presentation to a user. In some examples, the interface includes an application programming interface or the like. Examples of a family of graphs is shown in FIGS. 12 and 13. A meta-parameter to optimize over includes size of the graph, dynamic range of the problem, and connectivity of the graph.

At 1904, the hybrid computer receives a problem graph and a meta-parameter. At 1906, the hybrid computer checks for a suitable graph in the family of graphs subject to optimization over the meta-parameter. For example, if the problem graph has a maximum vertex degree of 10, then a logical graph with a maximum vertex degree of 10 may be a suitable graph.

At 1908, the hybrid computer creates an embedding for the problem for the logical graph, G_{L}. That is the hybrid computer creates a mapping from the problem graph to the logical graph. In the event of a failure in creating the mapping, the hybrid computer may, for example, cause an error message to be returned.

Processing continues at 1708-1720 (FIG. 18).

The types of problems that may be solved by any particular embodiment of a quantum processor, as well as the relative size and complexity of such problems, typically depend on many factors. Two such factors may include the number of qubits in the quantum processor and the connectivity (i.e., the availability of communicative couplings) between the qubits in the quantum processor.

This disclosure includes systems, devices, articles and methods related to hybrid computers comprising one or more digital processor based device and an analog processor (e.g., quantum processor) in communicative coupling. This disclosure includes designs, layouts, and architectures for quantum processors comprising qubits and couplers, and techniques for operating the same. The quantum processor includes qubits and couplers arranged between the qubits to provide communicative coupling between pairs of qubits as directed by the digital processor based device. As well, the digital processor based device can direct a set of local biases be applied to each qubit. See FIGS. 1 and 2.

The quantum processor includes a hardware graph—a specific topology of qubits. As shown in FIGS. 4-7, and 13 and related description this topology can be modified by forcing connected sets of qubits to act as a single logical qubit. A logical qubit can be referred to as a chain. Physically, the couplers within a chain are set to a strong ferromagnetic coupling value. The length of a chain is the number of qubits within the chain. These logical qubits and the couplings between them define a logical graph. See FIGS. 4 and 5 for an example of a hardware graph converted to a logical graph. See FIGS. 9-11 for adjacency matrices of new logical graphs based on a hardware graph.

The chains can be chosen with regularity in at least two parameters: i) location in the hardware graph, and/or ii) length of chain. In some examples, the chains have a regular repeating pattern (e.g., repeating is shape, orientation, distance) in the hardware graph. As well, the chains have the same length. However, chain shape can vary in a sub-pattern within the pattern. See FIGS. 4-7 and 13. This regularity allows the chains to be shimmed for improved performance. See, FIGS. 15 and 16.

In some examples, after accounting for edge effects the chains are homogeneous or evenly distributed in length. There is reason to believe that this will contribute to improved and predictable performance of the quantum annealing platform. Examples of chain length are given in FIGS. 9-11.

As well, a user of the quantum annealing platform has an effective increase in energy scale in the problem embedded in the logical graph. This is also known as an increased dynamic range. That is, the problem can be specified with greater precision. For example, the local biases applied to a logical qubit can be distributing of the physical qubits within a logical qubits. See for example FIG. 17. In some examples, a coupling value between two logical qubits can be distributed over a plurality of physical couplers between the logical qubits. See for example FIG. 17.

In addition, the logical qubits and related logical graph can be chosen so that the structure of the embedded problem is similar to the structure of the hardware graph, but with modified parameters. One useful parameter is connectivity. A logical qubit can have a greater connectivity than a physical qubit. Thus a problem can be more easily be embedded in a given logical graph than the hardware graph it is based on.

If the hardware graph exhibits self-similarity, then a further embedding can be done on the logical graph to create a new graph with increased dynamic range and/or connectivity. Thus a graph can be collapsed on itself. This is shown in overview in FIG. 12. An example of unit cell with self-similarity is shown in FIG. 14. If the first collapse operation does not yield a logical graph with suitable properties, another collapsing applied to the graph might. An automated selection of a logical graph is shown in FIG. 19 and the associated description.

A user of a quantum annealing platform can make use of logical graphs in a variety of ways. For example, the user can select a logical graph to embed a problem in. See FIG. 17. As well, a user can create their own logical graph from a hardware graph. See FIG. 18. A user can provide a problem graph and a quantum annealing platform can determine which graph from a plurality of logical graphs is suitable for the problem graph. See FIG. 19. In some examples, plurality of logical graphs is a family of graphs exhibiting self-similarity.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other methods of quantum computation, not necessarily the exemplary methods for quantum computation generally described above.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet including U.S. patent applications with the following serial numbers and filing dates: Ser. No. 62/114,406, filed 2015 Feb. 10; Ser. No. 61/858,023, filed 2013 Jul. 24; Ser. No. 14/340,291 filed 2014 Jul. 24; Ser. No. 61/863,360 filed 2013 Aug. 7; Ser. No. 14/453,883 filed 2014 Aug. 7; Ser. No. 62/040,643 filed 2014 Aug. 22; Ser. No. 62/040,890 filed 2014 Aug. 22; 61/983,370 filed 2014 Apr. 23; Ser. No. 61/951,708 filed 2014 Mar. 12, are incorporated herein by reference, in their entirety. Aspects of the embodiments can be modified, if necessary, to employ systems, circuits, and concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system for use in quantum processing, comprising:
at least one nontransitory processor-readable medium that stores at least one of processor executable instructions or data; and
at least one processor communicatively coupled to the least one nontransitory processor-readable medium, and which, in response to execution of the at least one of processor executable instructions or data:
causes a presentation of a user interface which allows a user to specify a first value for a dimension of a hypercube graph at a first time; and
based at least in part on the first value for the dimension of the hypercube graph, causes a first number of chains of qubits of the quantum processor to be formed in a hardware graph of a quantum processor to implement a first logical graph in the hardware graph of the quantum processor, the first logical graph which corresponds to the hypercube graph of the dimension specified by the first value.

2-10. (canceled)

11. The system of claim 1 wherein the at least one of processor further:
causes a presentation of the user interface which allows the user to specify a second value for a dimension of a hypercube graph at a second time, the second value different from the first value and the second time different from the first time; and
based at least in part on the second value for the dimension of the hypercube graph, causes a second number of chains of qubits of the quantum processor to be formed in the hardware graph of the quantum processor to implement a second logical graph in the hardware graph of the quantum processor, the second logical graph which corresponds to the hypercube graph of the dimension specified by the second value.

12. The system of claim 1 wherein the second value is less than the first value, and the at least one processor causes the hypercube graph to collapse.

13. The system of claim 1 wherein the second value is less than the first value, and the at least one processor causes the hypercube graph to expand.

14. The system of claim 1 wherein the at least one processor includes at least one digital processor, and the at least one digital processor causes a presentation of at least one of a set of integers or an integer entry field to specify the dimension of the hypercube graph.

15. The system of claim 1 wherein the at least one processor includes at least one digital processor, and the at least one digital processor causes chains of qubits to be formed in the hardware graph on the quantum processor with regularity in both a chain length of each chain of qubits and location of each chain of qubits in at least a first unit cell portion of the quantum processor.

16. The system of claim 1 wherein the at least one processor includes at least one digital processor, and the at least one digital processor causes each of a plurality of couplers of the quantum processor to apply a strong ferromagnetic coupling between respective pairs of qubits in each of the chains of qubits to form the respective chain of qubits.

17. The system of claim 1 wherein the at least one digital processor is communicatively coupled to control the quantum processor via a control system which applies control signals to the couplers, at least some of the controls signals applied to the couplers to establish the selected logical graph before the first problem is embedded in the quantum processor.

18. The system of claim 17 wherein the at least one digital processor is remotely located from the control system, located in a different room from the control system.

19. The system of claim 15 wherein the at least one digital processor causes a coupling value between at least one pair of qubits in at least one of the chains of qubits to be distributed over two or more couplers that communicatively couple the qubits of the pair of qubits.

20. The system of claim 15 wherein each of the chains of qubits comprise a respective logical qubit, and the at least one digital processor further causes a local bias value to be applied to each of the logical qubits.

21. The system of claim 20 wherein the at least one digital processor further causes the local bias value for at least one of the chains of qubits to be distributed over two or more of the qubits of the respective chain of qubits.

22-26. (canceled)

27. A method of operation in a hybrid computer that comprises both quantum processor and at least one processor-based device communicatively coupled to one another, the quantum processor comprising a plurality of qubits, and a plurality of couplers, wherein each coupler provides controllable communicative coupling between two of the plurality of qubits, the method comprising:
causing a presentation of a user interface which allows a user to specify a first value for a dimension of a hypercube graph at a first time; and
based at least in part on the first value for the dimension of the hypercube graph, causing a first number of chains of qubits of the quantum processor to be formed in a hardware graph of a quantum processor to implement a first logical graph in the hardware graph of the quantum processor, the first logical graph which corresponds to the hypercube graph of the dimension specified by the first value.

28-36. (canceled)

37. The method of claim 27 wherein causing a presentation of a user interface comprises causing a presentation of a user interface which allows the user to specify a second value for a dimension of a hypercube graph at a second time, the second value different from the first value and the second time different from the first time; and the method further comprising:
based at least in part on the second value for the dimension of the hypercube graph, causing a second number of chains of qubits of the quantum processor to be formed in the hardware graph of the quantum processor to implement a second logical graph in the hardware graph of the quantum processor, the second logical graph which corresponds to the hypercube graph of the dimension specified by the second value.

38. The method of claim 27, further comprising: collapsing the hypercube graph when the second value is less than the first value.

39. The method of claim 27, further comprising: expanding the hypercube graph when the second value is less than the first value.

40. The method of claim 27 wherein causing a presentation of a user interface comprises: presenting at least one of a set of integers or an integer entry field to specify the dimension of the hypercube graph.

41-45. (canceled)

46. The method of claim 27 wherein forming chains of qubits in the hardware graph comprises:
forming chains of qubits in the hardware graph on the quantum processor with regularity in both a chain length of each chain of qubits and location of each chain of qubits in at least a first unit cell portion of the quantum processor.

47. The method of claim 27 wherein forming chains of qubits in the hardware graph comprises: causing each of a sub-set of the plurality of couplers of the quantum processor to apply a strong ferromagnetic coupling between respective pairs of qubits in each of the chains of qubits to form the respective chain of qubits.

48. The method of claim 47 wherein the at least one processor-based device is communicatively coupled to control the quantum processor via a control system, and the method further comprising applying control signals to the couplers, wherein at least some of the controls signals applied to the couplers to establish the selected logical graph before the first problem is embedded in the quantum processor.

49. The method of claim 47, further comprising: causing a coupling value between at least one pair of qubits in at least one of the chains of qubits to be distributed over two or more couplers that communicatively couple the qubits of the pair of qubits.

50. The method of claim 27, further comprising: applying a local bias value for a respective logical qubit comprised of a respective chain of qubits to the respective logical qubit.

51. The method of claim 50, further comprising: distributing the local bias value for the respective logical qubit comprised of the respective chains of qubits over two or more qubits in the respective chain of qubit.

52-60. (canceled)

61. A quantum processing system, comprising:
at least one quantum processor that comprises a plurality of qubits and a plurality of couplers;
at least one control system communicatively coupled to the least one quantum processor to, prior to an embedding of a problem in a hardware graph of the quantum processor, selectively form chains of qubits to embed a first logical graph of a first size n in at least one unit cell of the hardware graph of the quantum processor, where the number of qubits in the logical graph available to embed the problem is equal to 2ⁿ, the number of couplers between the qubits available to embed the problem is equal to n*2⁽ⁿ⁻¹⁾, and the number edges in the at least one unit cell and incident on each qubit in the at least one unit cell is n.
